(19) United States
(12) Patent Application Publication
(10) Pub. No.: US 2019/0308391 A1
(43) Pub. Date: Oct. 10, 2019

(54) GRAPHITE COMPOSITE FILM AND MANUFACTURING METHOD THEREFOR

(71) Applicant: Panasonic Intellectual Property Management Co., Ltd., Osaka (JP)

(72) Inventors: YASUHIRO TSUDA, Osaka (JP); JUNICHIRO HIRATSUKA, Shimane (JP); CHIHIRO SATOU, Hokkaido (JP)

(21) Appl. No.: 16/451,186

(22) Filed: Jun. 25, 2019

Related U.S. Application Data
(63) Continuation of application No. PCT/JP2018/000610, filed on Jan. 12, 2018.

(30) Foreign Application Priority Data
Jan. 31, 2017 (JP) 2017-015757
Jan. 31, 2017 (JP) 2017-015758

(51) Int. Cl. B32B 9/00; B32B 15/08; B32B 27/18; B32B 7/12; B32B 9/04; C01B 32/20; B32B 37/20; B32B 15/20

(52) U.S. Cl. CPC B32B 9/007; B32B 15/08; B32B 27/18; B32B 15/20; B32B 9/045; C01B 32/20; B32B 37/20; B32B 7/12

(57) ABSTRACT

Provided is a graphite composite film that is capable of attaining both a measure against heat and a measure against electromagnetic noise and that is less likely to cause degradation of electromagnetic wave shielding properties. The graphite composite film includes a graphite layer, a first electrically conductive adhesive layer, and a metal layer containing a first metal disposed in this order. A first rust-proofing layer is interposed between the first electrically conductive adhesive layer and the metal layer, and a second rust-proofing layer is disposed on a surface of the metal layer opposite from a surface on a first rust-proofing layer-disposed side of the metal layer.

### BACKGROUND

### 1. Technical Field

The present disclosure relates to a graphite composite film and a manufacturing method for the graphite composite film.

### 2. Description of the Related Art

Along with requirements for high performance and reduction in size and thickness of electronic devices such as a communication device and a personal computer, many electronic components are disposed without a gap in a limited space within a housing of an electronic device in recent years. These electronic components become a heat source or electromagnetic noise to possibly cause an operation error of the electronic device. Therefore, a measure against heat and a measure against electromagnetic noise are important issues.

As such a measure against heat and a measure against electromagnetic noise, Patent Literature 1 discloses a graphite composite film obtained by stacking a graphite film, an electrically conductive adhesion layer having a surface resistance within a prescribed range, a metal thin film formed of copper, and a protection film layer in this order.

### CITATION LIST

### Patent Literature

PTL 1: Unexamined Japanese Patent Publication No. 2009-280433

### SUMMARY

However, using the graphite composite film described in PTL 1 by attaching the graphite composite film to an electronic component disposed within a housing of an electronic device has possibly caused degradation over time of electromagnetic wave shielding properties against an electromagnetic wave in a high-frequency zone (for example, a 500 MHz zone).

Thus, an object of the present disclosure is to provide a graphite composite film that is capable of attaining both a measure against heat and a measure against electromagnetic noise and that is less likely to cause the degradation over time of electromagnetic wave shielding properties, and a manufacturing method for the graphite composite film.

A graphite composite film according to a first aspect includes a graphite layer, a first electrically conductive adhesive layer, and a metal layer containing a first metal disposed in this order. A first rust-proofing layer is interposed between the first electrically conductive adhesive layer and the metal layer. A second rust-proofing layer is disposed on a surface of the metal layer opposite from a surface on a first rust-proofing layer-disposed side of the metal layer.

A manufacturing method for a graphite composite film according to a second aspect includes following steps. That is, vapor deposition of a first metal is performed on a first surface of a protection film having the first surface and a second surface, to form a metal layer. First rust proofing is performed on a surface of the metal layer to form a first rust-proofing layer. A first electrically conductive adhesive sheet is disposed on a surface of the first rust-proofing layer, thus laminating the surface with the first electrically conductive adhesive sheet. Then, the protection film is peeled. Second rust proofing is performed on a surface of the metal layer opposite from the surface on a first rust-proofing layer-disposed side of the metal layer to form a second rust-proofing layer. Thus, an electrically conductive adhesive sheet-attached metal vapor-deposited film is prepared. This manufacturing method further includes a following step. That is, a second electrically conductive adhesive sheet is disposed on a first surface of a graphite film having the first surface and a second surface, thus laminating the first surface with the second electrically conductive adhesive sheet. Thus, an electrically conductive adhesive sheet-attached graphite film is prepared. This manufacturing method further includes a following step. That is, the electrically conductive adhesive sheet-attached metal vapor-deposited film and the electrically conductive adhesive sheet-attached graphite film are subjected to lamination, with a surface of the first electrically conductive adhesive sheet and the second surface of the graphite film disposed so as to overlap one another.

A manufacturing method for a graphite composite film according to a third aspect includes following steps. That is, vapor deposition of a second metal and a first metal is performed in this order on a first surface of a protection film having the first surface and a second surface. Thus, a second rust-proofing layer containing the second metal and a metal layer containing the first metal are formed. Rust proofing is performed on a surface of the metal layer to form a first rust-proofing layer. A first electrically conductive adhesive sheet is disposed on a surface of the first rust-proofing layer, thus laminating the surface with the first electrically conductive adhesive sheet. Then, the protection film is peeled. Thus, an electrically conductive adhesive sheet-attached metal vapor-deposited film is prepared. This manufacturing method further includes a following step. That is, a second electrically conductive adhesive sheet is disposed on a first surface of a graphite film having the first surface and a second surface, thus laminating the first surface with the second electrically conductive adhesive sheet. Thus, an electrically conductive adhesive sheet-attached graphite film is prepared. This manufacturing method further includes a following step. That is, the electrically conductive adhesive sheet-attached metal vapor-deposited film and the electrically conductive adhesive sheet-attached graphite film are subjected to lamination, with a surface of the first electrically conductive adhesive sheet and the second surface of the graphite film disposed so as to overlap one another.

A graphite composite film according to a fourth aspect includes a graphite layer, a first electrically conductive adhesive layer, a metal layer containing a first metal, and a protection film disposed in this order. A rust-proofing layer is interposed between the first electrically conductive adhesive layer and the metal layer.

A manufacturing method for a graphite composite film according to a fifth aspect includes following steps. That is, vapor deposition of a first metal is performed on a first surface of a protection film having the first surface and a second surface, to form a metal layer. Rust proofing is performed on a surface of the metal layer to form a rust-proofing layer. A first electrically conductive adhesive sheet is disposed on a surface of the rust-proofing layer, thus laminating the surface with the first electrically conductive adhesive sheet. Thus, an electrically conductive adhesive sheet-attached metal vapor-deposited film is prepared. This manufacturing method further includes a following step. That is, a second electrically conductive adhesive sheet is disposed on a first surface of a graphite film having the first surface and a second surface, thus laminating the first surface with the second electrically conductive adhesive sheet. Thus, an electrically conductive adhesive sheet-attached graphite film is prepared. This manufacturing method further includes a following step. That is, the electrically conductive adhesive sheet-attached metal vapor-deposited film and the electrically conductive adhesive sheet-attached graphite film are subjected to lamination, with a surface of the first electrically conductive adhesive sheet and the second surface of the graphite film disposed so as to overlap one another.

The present disclosure is capable of attaining both a measure against heat and a measure against electromagnetic noise and is less likely to cause degradation of electromagnetic wave shielding properties.

### BRIEF DESCRIPTION OF THE DRAWINGS

FIG. 1A is a schematic sectional view of a main portion of a graphite composite film according to an exemplary embodiment of the present disclosure;

FIG. 1B is a schematic sectional view of an end portion of the graphite composite film according to the exemplary embodiment of the present disclosure;

FIG. 2A is a schematic sectional view illustrating part of a manufacturing method for a graphite composite film according to a first exemplary embodiment of the present disclosure, specifically one example of a step of preparing an electrically conductive adhesive sheet-attached metal vapor-deposited film;

FIG. 2B is a schematic sectional view illustrating the part of the manufacturing method for the graphite composite film according to the first exemplary embodiment of the present disclosure, specifically the one example of the step of preparing an electrically conductive adhesive sheet-attached metal vapor-deposited film;

FIG. 2C is a schematic sectional view illustrating the part of the manufacturing method for the graphite composite film according to the first exemplary embodiment of the present disclosure, specifically the one example of the step of preparing an electrically conductive adhesive sheet-attached metal vapor-deposited film;

FIG. 2D is a schematic sectional view illustrating the part of the manufacturing method for the graphite composite film according to the first exemplary embodiment of the present disclosure, specifically the one example of the step of preparing an electrically conductive adhesive sheet-attached metal vapor-deposited film;

FIG. 2E is a schematic sectional view illustrating the part of the manufacturing method for the graphite composite film according to the first exemplary embodiment of the present disclosure, specifically the one example of the step of preparing an electrically conductive adhesive sheet-attached metal vapor-deposited film;

FIG. 2F is a schematic sectional view illustrating the part of the manufacturing method for the graphite composite film according to the first exemplary embodiment of the present disclosure, specifically the one example of the step of preparing an electrically conductive adhesive sheet-attached metal vapor-deposited film;

FIG. 2G is a schematic sectional view illustrating the part of the manufacturing method for the graphite composite film according to the first exemplary embodiment of the present disclosure, specifically the one example of the step of preparing an electrically conductive adhesive sheet-attached metal vapor-deposited film;

FIG. 3A is a schematic sectional view illustrating part of a manufacturing method for a graphite composite film according to a second exemplary embodiment of the present disclosure, specifically one example of a step of preparing an electrically conductive adhesive sheet-attached metal vapor-deposited film;

FIG. 3B is a schematic sectional view illustrating the part of the manufacturing method for the graphite composite film according to the second exemplary embodiment of the present disclosure, specifically the one example of the step of preparing an electrically conductive adhesive sheet-attached metal vapor-deposited film;

FIG. 3C is a schematic sectional view illustrating the part of the manufacturing method for the graphite composite film according to the second exemplary embodiment of the present disclosure, specifically the one example of the step of preparing an electrically conductive adhesive sheet-attached metal vapor-deposited film;

FIG. 3D is a schematic sectional view illustrating the part of the manufacturing method for the graphite composite film according to the second exemplary embodiment of the present disclosure, specifically the one example of the step of preparing an electrically conductive adhesive sheet-attached metal vapor-deposited film;

FIG. 3E is a schematic sectional view illustrating the part of the manufacturing method for the graphite composite film according to the second exemplary embodiment of the present disclosure, specifically the one example of the step of preparing an electrically conductive adhesive sheet-attached metal vapor-deposited film;

FIG. 3F is a schematic sectional view illustrating the part of the manufacturing method for the graphite composite film according to the second exemplary embodiment of the present disclosure, specifically the one example of the step of preparing an electrically conductive adhesive sheet-attached metal vapor-deposited film;

FIG. 3G is a schematic sectional view illustrating the part of the manufacturing method for the graphite composite film according to the second exemplary embodiment of the present disclosure, specifically the one example of the step of preparing an electrically conductive adhesive sheet-attached metal vapor-deposited film;

FIG. 4A is a schematic sectional view illustrating part of the manufacturing methods for the graphite composite films according to the first exemplary embodiment and the second exemplary embodiment of the present disclosure, specifically a step of preparing an electrically conductive adhesive sheet-attached graphite film;

FIG. 4B is a schematic sectional view illustrating the part of the manufacturing methods for the graphite composite films according to the first exemplary embodiment and the second exemplary embodiment of the present disclosure, specifically the step of preparing an electrically conductive adhesive sheet-attached graphite film;

FIG. 4C is a schematic sectional view illustrating part of the manufacturing methods for the graphite composite films according to the first exemplary embodiment and the second exemplary embodiment of the present disclosure, specifically a step of subjecting the electrically conductive adhesive sheet-attached metal vapor-deposited film and the electrically conductive adhesive sheet-attached graphite film to lamination;

FIG. 4D is a schematic sectional view illustrating the part of the manufacturing methods for the graphite composite films according to the first exemplary embodiment and the second exemplary embodiment of the present disclosure, specifically the step of subjecting the electrically conductive adhesive sheet-attached metal vapor-deposited film and the electrically conductive adhesive sheet-attached graphite film to lamination;

FIG. 5A is a schematic sectional view illustrating part of a manufacturing method for a graphite composite film according to a comparative example, specifically a step of preparing an electrically conductive adhesive sheet-attached metal vapor-deposited film of the comparative example;

FIG. 5B is a schematic sectional view illustrating the part of the manufacturing method for the graphite composite film according to the comparative example, specifically the step of preparing the electrically conductive adhesive sheet-attached metal vapor-deposited film of the comparative example;

FIG. 5C is a schematic sectional view illustrating the part of the manufacturing method for the graphite composite film according to the comparative example, specifically the step of preparing the electrically conductive adhesive sheet-attached metal vapor-deposited film of the comparative example;

FIG. 5D is a schematic sectional view illustrating the part of the manufacturing method for the graphite composite film according to the comparative example, specifically the step of preparing the electrically conductive adhesive sheet-attached metal vapor-deposited film of the comparative example;

FIG. 5E is a schematic sectional view illustrating the part of the manufacturing method for the graphite composite film according to the comparative example, specifically the step of preparing the electrically conductive adhesive sheet-attached metal vapor-deposited film of the comparative example;

FIG. 6A is a schematic sectional view of a main portion of a graphite composite film according to a third exemplary embodiment of the present disclosure;

FIG. 6B is a schematic sectional view of an end portion of the graphite composite film according to the third exemplary embodiment of the present disclosure;

FIG. 7A is a schematic sectional view for illustrating a manufacturing method for the graphite composite film according to the third exemplary embodiment of the present disclosure, specifically a step of preparing an electrically conductive adhesive sheet-attached metal vapor-deposited film;

FIG. 7B is a schematic sectional view for illustrating the manufacturing method for the graphite composite film according to the third exemplary embodiment of the present disclosure, specifically the step of preparing an electrically conductive adhesive sheet-attached metal vapor-deposited film;

FIG. 7C is a schematic sectional view for illustrating the manufacturing method for the graphite composite film according to the third exemplary embodiment of the present disclosure, specifically the step of preparing an electrically conductive adhesive sheet-attached metal vapor-deposited film;

FIG. 7D is a schematic sectional view for illustrating the manufacturing method for the graphite composite film according to the third exemplary embodiment of the present disclosure, specifically the step of preparing an electrically conductive adhesive sheet-attached metal vapor-deposited film;

FIG. 7E is a schematic sectional view for illustrating the manufacturing method for the graphite composite film according to the third exemplary embodiment of the present disclosure, specifically the step of preparing an electrically conductive adhesive sheet-attached metal vapor-deposited film;

FIG. 7F is a schematic sectional view for illustrating the manufacturing method for the graphite composite film according to the third exemplary embodiment of the present disclosure, specifically a step of preparing an electrically conductive adhesive sheet-attached graphite film;

FIG. 7G is a schematic sectional view for illustrating the manufacturing method for the graphite composite film according to the third exemplary embodiment of the present disclosure, specifically the step of preparing an electrically conductive adhesive sheet-attached graphite film;

FIG. 7H is a schematic sectional view for illustrating the manufacturing method for the graphite composite film according to the third exemplary embodiment of the present disclosure, specifically a step of subjecting the electrically conductive adhesive sheet-attached metal vapor-deposited film and the electrically conductive adhesive sheet-attached graphite film to lamination; and

FIG. 7I is a schematic sectional view for illustrating the manufacturing method for the graphite composite film according to the third exemplary embodiment of the present disclosure, specifically the step of subjecting the electrically conductive adhesive sheet-attached metal vapor-deposited film and the electrically conductive adhesive sheet-attached graphite film to lamination.

### DETAILED DESCRIPTION

Hereinafter, exemplary embodiments according to the present disclosure are described below.

### First Exemplary Embodiment

### [Graphite Composite Film 1]

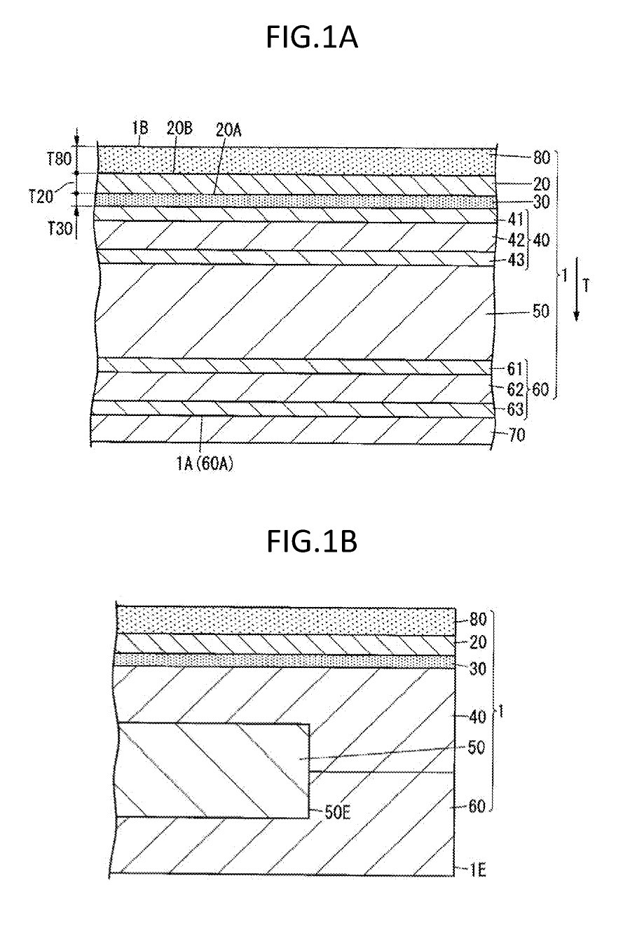

FIG. 1A is a schematic sectional view of a main portion of graphite composite film 1 according to a first exemplary embodiment. FIG. 1B is a schematic sectional view of an end portion of graphite composite film 1.

Graphite composite film 1 according to the present exemplary embodiment includes, as shown in FIG. 1A, second electrically conductive adhesive layer 60, graphite layer 50, first electrically conductive adhesive layer 40, metal layer 20, first rust-proofing layer 30, second rust-proofing layer 80, and first peeling sheet 70. Metal layer 20 contains a first metal. Second electrically conductive adhesive layer 60, graphite layer 50, first electrically conductive adhesive layer 40, and metal layer 20 are stacked in this order. First rust-proofing layer 30 is interposed between first electrically conductive adhesive layer 40 and metal layer 20. Second rust-proofing layer 80 is disposed on a surface of metal layer 20 opposite from a surface on first rust-proofing layer 30-disposed side of metal layer 20. Further, first peeling sheet 70 is fitted to surface 60A of second electrically conductive adhesive layer 60.

Graphite composite film 1 structured as described above is capable of attaining both a measure against heat and a measure against electromagnetic noise of an electromagnetic device only by being attached to an object. That is, graphite composite film 1 that includes graphite layer 50 having excellent thermal conductivity is capable of dissipating heat of the object in a plane direction of graphite composite film 1 to decrease a temperature of the object. The plane direction refers to a direction perpendicular to a thickness direction of graphite layer 50. Graphite composite film 1 that includes metal layer 20 is capable of reflecting an electromagnetic wave having reached metal layer 20. This phenomenon is supposed to be caused because an electromagnetic wave having reached metal layer 20 generates eddy current in metal layer 20 by electromagnetic induction and the eddy current reflects the electromagnetic wave. Particularly, when the object has electric conductivity, metal layer 20 is electrically connected to the object and is thus earthed, so that the eddy current generated in metal layer 20 is released (grounded) to the object, resulting in the graphite composite film exhibiting more excellent electromagnetic wave shielding properties.

Further, first rust-proofing layer 30 interposed between first electrically conductive adhesive layer 40 and metal layer 20 makes first surface 20A on the first rust-proofing layer 30-disposed side of metal layer 20 less likely to be discolored (hereinafter, referred to as corrosion) and the electromagnetic wave shielding properties less likely to be degraded. Further, second rust-proofing layer 80 disposed on the surface (second surface 20B) of metal layer 20 opposite from first surface 20A of metal layer 20 makes second surface 20B of metal layer 20 less likely to be discolored (corroded) and the electromagnetic wave shielding properties less likely to be degraded. These phenomena are supposed to be caused because first rust-proofing layer 30 and second rust-proofing layer 80 suppress progress of the corrosion of metal layer 20 to make sheet resistance of metal layer 20 less likely to rise over time and energy of generated eddy current less likely to be converted to thermal energy.

In end surface 1E of graphite composite film 1, end surface 50E of graphite layer 50 is not exposed as shown in FIG. 1B. That is, end surface 50E of graphite layer 50 is covered with first electrically conductive adhesive layer 40 and second electrically conductive adhesive layer 60. This configuration is capable of preventing both rupture of graphite composite film 1 attributed to interlayer peeling in graphite layer 50 and powder dropping of graphite layer 50.

Graphite composite film 1 preferably has a thickness ranging from 15 μm to 800 μm, inclusive. It is possible to measure the thickness of graphite composite film 1 based on an image obtained by observing a section of graphite composite film 1 with a scanning electron microscope (SEM). It is also possible to similarly measure thicknesses of following layers forming graphite composite film 1.

It is possible to use graphite composite film 1 by, for example, peeling first peeling sheet 70 from graphite composite film 1 just before use and attaching the graphite composite film to an object. Examples of the object include an electronic component disposed within a housing of an electronic device. Examples of the electronic component include a rear chassis of a liquid crystal unit, a light-emitting diode (LED) substrate having a light-emitting diode (LED) light source used as, for example, a back light of a liquid crystal image display device, a power amplifier, and a large scale integrated circuit (LSI). As first peeling sheet 70, it is possible to use, for example, one obtained by performing, with, for example, a silicone resin, a peeling treatment on one or both surfaces of paper, a resin film, laminated paper obtained by stacking paper and a resin film, or paper filled with, for example, clay or polyvinyl alcohol. Examples of the paper include kraft paper, glassine paper, and pure paper. Examples of the resin film include polyethylene, polypropylene (oriented polypropylene (OPP) and cast polypropylene (CPP)), and polyethylene terephthalate (PET).

Graphite composite film 1 according to the present exemplary embodiment includes second electrically conductive adhesive layer 60, graphite layer 50, first electrically conductive adhesive layer 40, first rust-proofing layer 30, metal layer 20, and second rust-proofing layer 80 stacked in this order. The present disclosure, however, is not limited to this structure, and the graphite composite film may have any structure as long as graphite layer 50, first electrically conductive adhesive layer 40, first rust-proofing layer 30, metal layer 20, and second rust-proofing layer 80 are disposed in this order. Further, a layer that does not inhibit the effects of the present disclosure may be stacked between these layers.

Further, in graphite composite film 1 according to the present exemplary embodiment, end surface 50E of graphite layer 50 is covered with first electrically conductive adhesive layer 40 and second electrically conductive adhesive layer 60. The present disclosure, however, is not limited to this configuration, and end surface 50E of graphite layer 50 may be exposed.

In graphite composite film 1 according to the present exemplary embodiment, an end surface of metal layer 20 is exposed as shown in FIG. 1B. The present disclosure, however, is not limited to this configuration, and the end surface of metal layer 20 may be covered with second rust-proofing layer 80. The end surface of metal layer 20 that is covered with second rust-proofing layer 80 is less likely to be corroded and thus makes the electromagnetic wave shielding properties of graphite composite film 1 further less likely to be degraded.

### (Metal Layer 20)

Graphite composite film 1 includes metal layer 20. This configuration makes graphite composite film 1 have the electromagnetic wave shielding properties.

Metal layer 20 contains a first metal. The first metal may be appropriately selected according to a raw material for graphite composite film 1, and it is possible to use, for example, silver, copper, gold, aluminum, magnesium, tungsten, cobalt, zinc, nickel, brass, potassium, lithium, iron, platinum, tin, chromium, lead, or titanium. Among these metals, the first metal is preferably a raw material having a low volume specific resistance in a raw material for graphite composite film 1. This is because the raw material having a low volume specific resistance has an advantage of improving the electromagnetic wave shielding properties of graphite composite film 1. Further, the first metal is more preferably copper in terms of costs.

Metal layer 20 has a thickness ranging preferably from 0.10 μm to 5.00 μm, inclusive, more preferably from 0.50 μm to 2.00 μm, inclusive.

In the present exemplary embodiment, metal layer 20 has a solid form as a surface form when viewed in thickness direction. T of graphite composite film 1. The present disclosure, however, is not limited to this form. Exemplary alternatives of the surface form include a mesh form and a wire form. The solid form refers to a form that shows no gap over the surface of the metal layer viewed in thickness direction T of graphite composite film 1.

### (First Rust-Proofing Layer 30 and Second Rust-Proofing Layer 80)

Graphite composite film 1 includes first rust-proofing layer 30 and second rust-proofing layer 80. First rust-proofing layer 30 is interposed between first electrically conductive adhesive layer 40 and metal layer 20. Second rust-proofing layer 80 is disposed on second surface 20B of metal layer 20. That is, first rust-proofing layer 30 and second rust-proofing layer 80 are disposed on both surfaces of metal layer 20, respectively.

Graphite composite film 1 that includes first rust-proofing layer 30 makes first surface 20A of metal layer 20 less likely to be corroded. This phenomenon is supposed to be caused because first rust-proofing layer 30 makes, for example, components such as moisture and oxygen mainly contained in first electrically conductive adhesive layer 40 less likely to reach the surface of metal layer 20 and thus an electrochemical reaction between the raw material for metal layer 20 and the components in first electrically conductive adhesive layer 40 less likely to progress.

Graphite composite film 1 that includes second rust-proofing layer 80 makes second surface 20B of metal layer 20 less likely to be corroded. This phenomenon is supposed to be caused because second rust-proofing layer 80 makes, for example, components that come from mainly externally, such as moisture and oxygen less likely to reach the surface of metal layer 20 and thus an electrochemical reaction between the raw material for metal layer 20 and the components that come from externally less likely to progress. Further, second rust-proofing layer 80 is capable of preventing a flaw on second surface 20B of metal layer 20.

As first rust-proofing layer 30 and second rust-proofing layer 80, it is possible to use, for example, an organic coating film or a metal coating film.

First rust-proofing layer 30 and second rust-proofing layer 80 may be coating films of the same type or different types of coating films. That is, both first rust-proofing layer 30 and second rust-proofing layer 80 may be organic coating films and both first rust-proofing layer 30 and second rust-proofing layer 80 may be metal coating films. Alternatively, one of first rust-proofing layer 30 and second rust-proofing layer 80 may be an organic coating film and the other may be a metal coating film.

The organic coating film may be appropriately adjusted according to the raw material for metal layer 20, and examples of the organic coating film include a benzotriazole coating film, a triazine amine coating film, a mercapto benzimidazole coating film, a thiodipropionic acid ester coating film, and a benzimidazole coating film. Among these organic coating films, when the first metal is copper, that is, when metal layer 20 is formed of copper, the organic coating film is preferably a benzotriazole coating film. The benzotriazole coating film as the organic coating film makes metal layer 20 formed of copper less likely to be corroded.

The benzotriazole coating film is supposed to be a polymer complex coating film of mainly a copper ion and a benzotriazole anion or a benzotriazole derivative anion. As a raw material for the benzotriazole coating film, it is possible to use, for example, benzotriazole or a benzotriazole derivative. As the benzotriazole derivative, it is possible to use, for example, benzotriazole, 2-(5-methyl-2-hydroxyphenyl)benzotriazole, 1,2,3-benzotriazole, or 2-[2-hydroxy-3,5-bis(α,α-dimethylbenzyl)phenyl]-2H-benzotriazole. As a raw material for the triazine amine coating film, it is possible to use, for example, 2,4-diamino-6-[2′-methylimidazolyl-(1′)]-ethyl-s-triazine. As a raw material for the mercapto benzimidazole coating film, it is possible to use, for example, 2-mercaptobenzimidazole, 2-mercapto-5-methylbenzimidazole, or 2-mercapto-5-methoxybenzimidazole. As a raw material for the thiodipropionic acid ester coating film, it is possible to use, for example, distearyl-3,3′-thiodipropionate or dilauryl-3,3′-thiodipropionate. As a raw material for the benzimidazole coating film, it is possible to use, for example, 2-methylbenzimidazole, 5-methylbenzimidazole, 1-hydroxy-5-methoxy-2-methylbenzimidazole-3-oxide, or 2-aminobenzimidazole.

As a raw material for the metal coating film, it is possible to use a pure metal such as zinc, nickel, chromium, titanium, aluminum, gold, silver, or palladium. Alternatively, it is possible to use a rust-proofing metal such as an alloy containing these pure metals.

When first rust-proofing layer 30 is a metal coating film, the metal coating film preferably contains, as a first rust-proofing metal, at least one selected from the group consisting of zinc, nickel, chromium, titanium, aluminum, gold, silver, palladium, and an alloy of these metals. When the metal coating film contains the first rust-proofing metal, metal layer 20 formed of copper is less likely to be corroded.

When first rust-proofing layer 30 is a metal coating film, the metal coating film more preferably contains nickel. Nickel has high rust-proofing properties to make metal layer 20 formed of copper further less likely to be corroded. Further, nickel has high adhesiveness to copper to be capable of improving adhesiveness of first rust-proofing layer 30 containing nickel to metal layer 20 formed of copper. Therefore, even when the end surface of metal layer 20 is exposed as shown in FIG. 1B, for example, components such as moisture and oxygen are less likely to reach the surface of metal layer 20 from interface 20A between first rust-proofing layer 30 and metal layer 20.

When second rust-proofing layer 80 is a metal coating film, the metal coating film preferably contains, as a second rust-proofing metal, at least one selected from the group consisting of zinc, nickel, chromium, titanium, aluminum, gold, silver, palladium, and an alloy of these metals. When the metal coating film contains the second rust-proofing metal, metal layer 20 formed of copper is less likely to be corroded.

When second rust-proofing layer 80 is a metal coating film, the metal coating film more preferably contains nickel. Nickel has high rust-proofing properties to make metal layer 20 formed of copper further less likely to be corroded. Further, nickel has high adhesiveness to copper to be capable of improving adhesiveness of second rust-proofing layer 80 containing nickel to metal layer 20 formed of copper. Therefore, even when the end surface of metal layer 20 is exposed as shown in FIG. 1B, for example, components such as moisture and oxygen are less likely to reach the surface of metal layer 20 from an interface between second rust-proofing layer 80 and metal layer 20.

When second rust-proofing layer 80 is a metal coating film, an insulating layer for preventing a short-circuit failure may be disposed on surface 1B of second rust-proofing layer 80 opposite from surface 20B on a metal layer 20-disposed side of second rust-proofing layer 80. In this case, a hole is made on part of the insulating layer, and it is possible to ground graphite layer 50 through the hole. When the insulating layer is disposed directly on metal layer 20 and the hole is made on the insulating layer for grounding, metal layer 20 causes an electrochemical reaction with, for example, components that come from externally, such as moisture and oxygen, to be corroded. Therefore, graphite composite film 1 that includes the metal coating film as second rust-proofing layer 80 is capable of preventing metal layer 20 from being corroded and of grounding graphite layer 50.

First rust-proofing layer 30 preferably has thickness T30 of less than or equal to thickness T20 of metal layer 20. This configuration enables graphite composite film 1 to both secure flexibility and reduce weight. Specifically, first rust-proofing layer 30 has thickness T30 ranging preferably from 0.002 μm to 0.100 μm, inclusive, more preferably from 0.002 μm to 0.040 μm, inclusive. First rust-proofing layer 30 has a solid form as a surface form when viewed in thickness direction. T of graphite composite film 1. That is, first rust-proofing layer 30 is provided without a gap over a whole region of first surface 20A of metal layer 20 and first surface 20A of metal layer 20 is not exposed, when viewed in thickness direction T of graphite composite film 1.

Second rust-proofing layer 80 preferably has thickness T80 of less than or equal to thickness T20 of metal layer 20. This configuration enables graphite composite film 1 to both secure flexibility and reduce weight. Specifically, second rust-proofing layer 80 has thickness T80 ranging preferably from 0.002 μm to 0.100 μm, inclusive, more preferably from 0.002 μm to 0.040 μm, inclusive. Second rust-proofing layer 80 has a solid form as a surface form when viewed in thickness direction T of graphite composite film 1. That is, second rust-proofing layer 80 is provided without a gap over a whole region of second surface 20B of metal layer 20 and second surface 20B of metal layer 20 is not exposed, when viewed in thickness direction T of graphite composite film 1.

### (First Electrically Conductive Adhesive Layer 40)

Graphite composite film 1 includes first electrically conductive adhesive layer 40. This configuration enables first rust-proofing layer 30 to be both adhesively fixed and electrically connected to graphite layer 50.

First electrically conductive adhesive layer 40 has a structure including, as shown in FIG. 1A, first adhesion layer 41, first metal substrate 42, and second adhesion layer 43 stacked in this order. First electrically conductive adhesive layer 40 that includes first metal substrate 42 has excellent electric conductivity. First electrically conductive adhesive layer 40 preferably has a thickness ranging from 2 μm to 300 μm, inclusive. First electrically conductive adhesive layer 40 has a solid form as a surface form when viewed in thickness direction T of graphite composite film 1.

First adhesion layer 41 is formed of electrically conductive adhesive agent having electric conductivity and adhesion. The electrically conductive adhesive agent contains, for example, a polymer and an electrically conductive filler and may further contain a crosslinking agent, an additive, or a solvent as necessary. As the polymer, it is possible to use, for example, an acrylic polymer, a rubber polymer, a silicone polymer, or a urethane polymer. Among these polymers, an acrylic polymer and a rubber polymer are preferably used. This is because when an acrylic polymer and a rubber polymer are used as the polymer, even attachment of graphite composite film 1 to a heat generating member is less likely to cause peeling by an influence of heat. As the acrylic polymer, it is possible to use one obtained by polymerizing a vinyl monomer such as a (meth)acrylic monomer. As the electrically conductive filler, it is possible to use, for example, a metal filler, a carbon filler, a metal composite filler, a metal oxide filler, or a potassium titanate filler. Examples of a raw material for the metal filler include silver, nickel, copper, tin, aluminum, and stainless steel. As a raw material for the carbon filler, it is possible to use, for example, Ketjen black, acetylene black, or graphite. As a raw material for the metal composite filler, it is possible to use, for example, aluminum-coated glass, nickel-coated glass, silver-coated glass, or nickel-coated carbon. As a raw material for the metal oxide filler, it is possible to use, for example, antimony-doped tin oxide, tin-doped indium oxide, or aluminum-doped zinc oxide. A shape of the electrically conductive filler is not particularly limited, and examples of the shape include powder, flakes, and fibers. As the crosslinking agent, it is possible to use, for example, an isocyanate crosslinking agent, an epoxy crosslinking agent, a chelate crosslinking agent, or an aziridine crosslinking agent. As the additive, it is possible to use a resin having adhesiveness for a purpose of further improving adhesive power of first adhesion layer 41. As the resin, it is possible to use, for example, a rosin resin; a terpene resin; an aliphatic (C5) or aromatic (C9) petroleum resin; a styrene resin; a phenolic resin; a xylene resin; or a methacrylic resin. First adhesion layer 41 has a thickness ranging preferably from 0.2 μm to 50 μm, inclusive, more preferably from 2 μm to 20 μm, inclusive.

As a raw material for first metal substrate 42, it is possible to use, for example, gold, silver, copper, aluminum, nickel, iron, tin, or an alloy of these metals. Among these metals, the raw material for first metal substrate 42 is preferably aluminum or copper from viewpoints of, for example, flexibility and thermal and electric conductivity, and is further preferably aluminum from a viewpoint of, for example, being less likely to promote corrosion by metal passivation. As the metal substrate formed of aluminum, it is possible to use a hard aluminum substrate formed of hard aluminum or a soft aluminum substrate formed of soft aluminum. The hard aluminum substrate is formed of aluminum foil obtained by subjecting aluminum to rolling. The soft aluminum substrate is formed of aluminum foil obtained by subjecting aluminum to rolling and annealing. As the metal substrate formed of copper, it is possible to use, for example, a substrate formed of electrolytic copper or a substrate formed of rolled copper. First metal substrate 42 has a thickness of preferably less than or equal to 200 μm, more preferably less than or equal to 100 μm.

Second adhesion layer 43 has electric conductivity and adhesion and contains, for example, a polymer and an electrically conductive filler. Second adhesion layer 43 has the same composition as first adhesion layer 41.

In the present exemplary embodiment, first electrically conductive adhesive layer 40 includes, as shown in FIG. 1A, first adhesion layer 41, first metal substrate 42, and second adhesion layer 43 stacked in this order. The present disclosure, however, is not limited to this structure. As an exemplary alternative, first electrically conductive adhesive layer 40 may be a single layer formed of an electrically conductive resin. In the present exemplary embodiment, second adhesion layer 43 has the same composition as first adhesion layer 41. The present disclosure, however, is not limited to this configuration, and the second adhesion layer may have a different composition from the composition of first adhesion layer 41 as long as the second adhesion layer has electric conductivity and adhesion.

### (Graphite Layer 50)

Graphite composite film. 1 includes graphite layer 50. This configuration enables graphite composite film 1 to both efficiently conduct and dissipate heat of an object should be attached the graphite composite film 1 and improve the electromagnetic wave shielding properties.

Graphite layer 50 has excellent electric conductivity and thermal conductivity in the plane direction. As a raw material for graphite layer 50, it is possible to use, for example, a layered carbon crystal graphite or a graphite intercalation compound formed through penetration of a chemical species between layers of graphite as a matrix. Examples of the chemical species include potassium, lithium, bromine, nitric acid, iron(III) chloride, tungsten hexachloride, and arsenic pentafluoride. Graphite layer 50 may be, for example, one obtained by stacking one or a plurality of graphite films. As the graphite film, it is possible to use, for example, a pyrolytic graphite sheet produced by firing a polymer film at high temperature or an expanded graphite sheet produced by an expanded graphite method. Among these graphite sheets, it is preferable to use, as the graphite film, a pyrolytic graphite sheet produced by firing a polymer film at high temperature. This is because the pyrolytic graphite sheet has a high coefficient of thermal conductivity and is light and flexible to give an advantage of easy processing. As the polymer film, it is possible to use, for example, a heat-resistance aromatic polymer such as a polyimide, a polyamide, or a polyamide-imide. A temperature for firing the polymer film preferably ranges from 2600° C. to 3000° C., inclusive. The expanded graphite method is a method for forming an intercalation compound in natural graphite lead by treating the natural graphite lead with a strong acid such as sulfuric acid, heating and expanding the intercalation compound to produce expanded graphite, and subjecting the expanded graphite to rolling to form the expanded graphite into a sheet. The graphite film preferably has a thickness ranging from 10 μm to 100 μm, inclusive.

The pyrolytic graphite sheet preferably has an a-b plane-direction coefficient of thermal conductivity ranging from 700 W/(m·K) to 1950 W/(m·K), inclusive and preferably has a c-axis-direction coefficient of thermal conductivity ranging from 8 W/(m·K) to 15 W/(m·K), inclusive. The pyrolytic graphite sheet preferably has a density ranging from 0.85 g/cm³ to 2.13 g/cm³, inclusive. As such a pyrolytic graphite sheet, it is possible to use, for example, a “PGS (registered trademark) graphite sheet” manufactured by Panasonic Corporation.

Graphite layer 50 has a thickness ranging preferably from 5 μm to 500 μm, inclusive, more preferably from 10 μm to 200 μm, inclusive. Graphite layer 50 has a solid form as a surface form when viewed in thickness direction T of graphite composite film 1.

### (Second Electrically Conductive Adhesive Layer 60)

Graphite composite film 1 includes second electrically conductive adhesive layer 60. This configuration enables graphite composite film 1 to be adherent to an object, allowing graphite composite film 1 to both easily exhibit excellent heat dissipation properties and electrically connect graphite layer 50 to the object. Thus, metal layer 20 is electrically connected to the object, so that when the object has electric conductivity, graphite composite film 1 has more excellent electromagnetic wave shielding properties.

Second electrically conductive adhesive layer 60 has a structure including, as shown in FIG. 1A, third adhesion layer 61, second metal substrate 62, and fourth adhesion layer 63 stacked in this order. Second electrically conductive adhesive layer 60 has the same structure as first electrically conductive adhesive layer 40.

In the present exemplary embodiment, second electrically conductive adhesive layer 60 has a structure including, as shown in FIG. 1A, third adhesion layer 61, second metal substrate 62, and fourth adhesion layer 63 stacked in this order. The present disclosure, however, is not limited to this structure. As an exemplary alternative, second electrically conductive adhesive layer 60 may be a single layer formed of an electrically conductive resin. In the present exemplary embodiment, second electrically conductive adhesive layer 60 has the same structure as first electrically conductive adhesive layer 40. The present disclosure, however, is not limited to this configuration, and the second electrically conductive adhesive layer may have a different structure from the structure of first electrically conductive adhesive layer 40 as long as the second electrically conductive adhesive layer has electric conductivity and adhesion.

### [Manufacturing Method for Graphite Composite Film According to First Exemplary Embodiment]

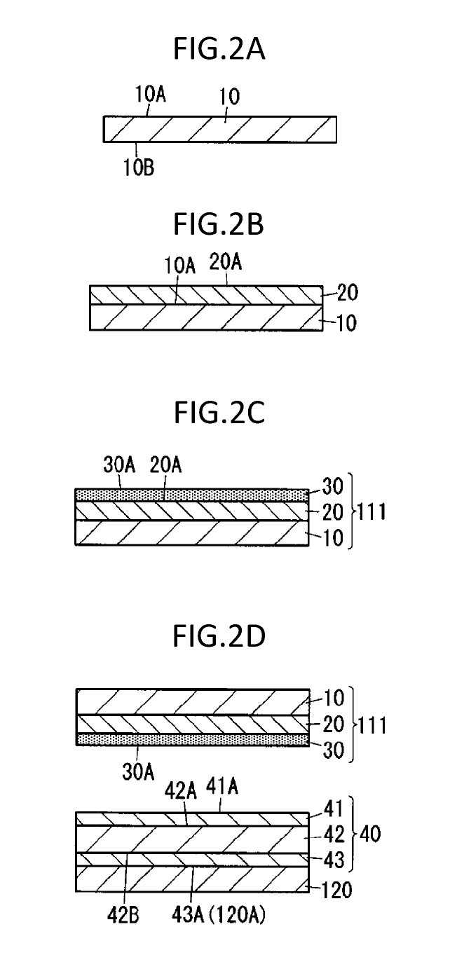

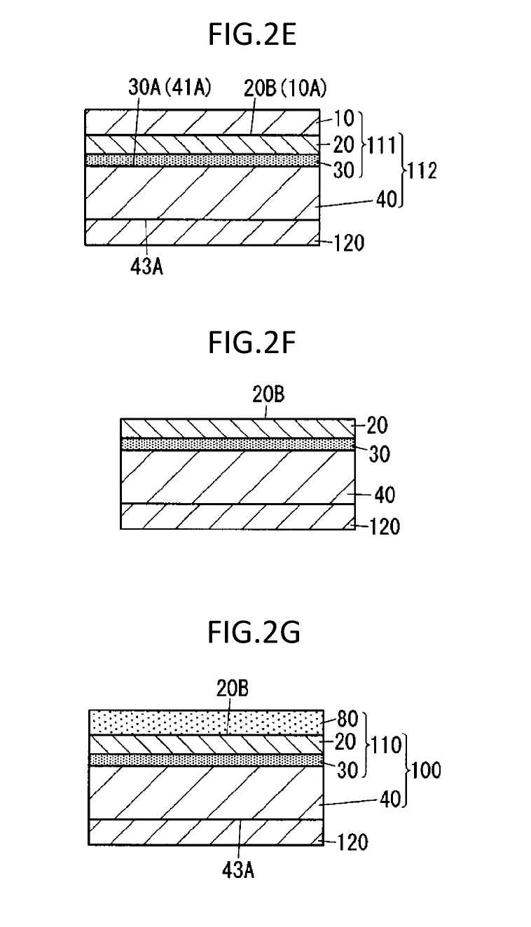

FIGS. 2A to 2G are schematic sectional views for illustrating part of a manufacturing method for graphite composite film 1 according to the first exemplary embodiment of the present disclosure. Specifically, FIGS. 2A to 2G are schematic sectional views for illustrating step (A) of preparing electrically conductive adhesive sheet-attached metal vapor-deposited film 100.

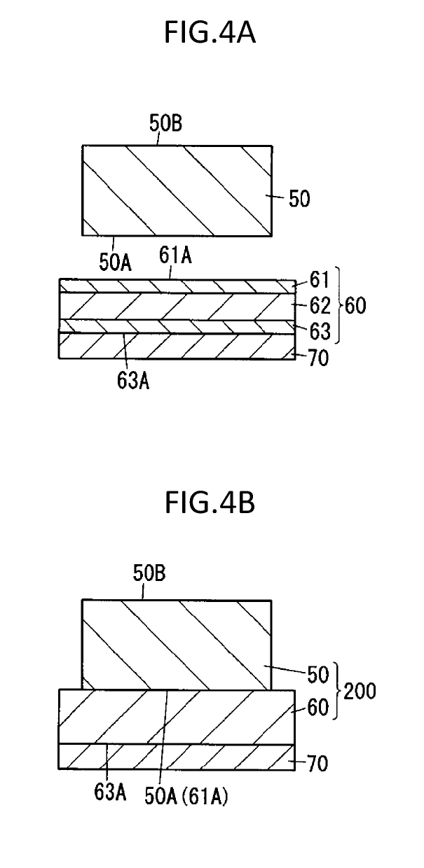

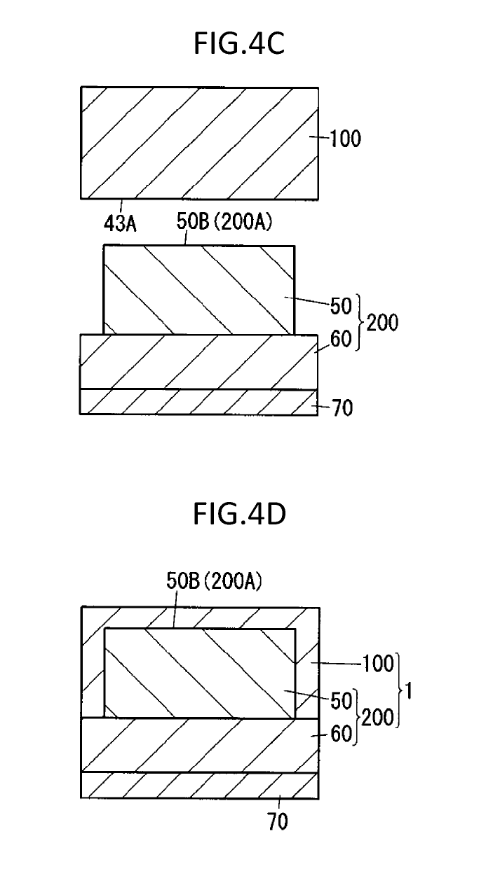

FIGS. 4A to 4D are schematic sectional views for illustrating part of the manufacturing method for graphite composite film 1 according to the first exemplary embodiment of the present disclosure. Specifically; FIGS. 4A and 4B are schematic sectional views for illustrating step (B) of preparing electrically conductive adhesive sheet-attached graphite film 200. FIGS. 4C and 4D are schematic sectional views for illustrating step (C) of subjecting electrically conductive adhesive sheet-attached metal vapor-deposited film 100 and electrically conductive adhesive sheet-attached graphite film 200 to lamination. Constituent members in FIGS. 2A to 2G and 4A to 4D that are identical with the constituent members of the exemplary embodiment shown in FIG. 1A are denoted by identical reference marks and are not described. Specifically, graphite film 50 corresponds to graphite layer 50, first electrically conductive adhesive sheet 40 corresponds to first electrically conductive adhesive layer 40, and second electrically conductive adhesive sheet 60 corresponds to second electrically conductive adhesive layer 60.

The manufacturing method for graphite composite film 1 according to the first exemplary embodiment includes step (1A) of preparing electrically conductive adhesive sheet-attached metal vapor-deposited film 100, step (1B) of preparing electrically conductive adhesive sheet-attached graphite film 200, and step (1C) of subjecting electrically conductive adhesive sheet-attached metal vapor-deposited film 100 and electrically conductive adhesive sheet-attached graphite film 200 to lamination. Steps (1A), (1B), and (1C) are performed in this order. These steps give graphite composite film 1 that is capable of attaining both a measure against heat and a measure against electromagnetic noise and that is less likely to cause degradation of electromagnetic wave shielding properties.

Step (1A): vapor deposition of a first metal is performed on first surface 10A of protection film 10 having first surface 10A and second surface 10B, to form metal layer 20. Then, first rust proofing is performed on first surface 20A of metal layer 20 to form first rust-proofing layer 30 and thus prepare first stacked body 111 (hereinafter, step (1a1)). First electrically conductive adhesive sheet 40 is disposed on surface 30A of first rust-proofing layer 30 of first stacked body 111, thus laminating surface 30A with first electrically conductive adhesive sheet 40 to prepare second stacked body 112 (hereinafter, step (1a2)). Protection film 10 of second stacked body 112 is peeled, and second rust proofing is performed on second surface 20B of metal layer 20 to form second rust-proofing layer 80 (hereinafter, step (1a3)). Thus, electrically conductive adhesive sheet-attached metal vapor-deposited film 100 is prepared that includes metal vapor-deposited film 110 and first electrically conductive adhesive sheet 40.

Step (1B): second electrically conductive adhesive sheet 60 is disposed on first surface 50A of graphite film 50 having first surface 50A and second surface 50B, thus laminating first surface 50A with second electrically conductive adhesive sheet 60.

Step (1C): electrically conductive adhesive sheet-attached metal vapor-deposited film 100 and electrically conductive adhesive sheet-attached graphite film 200 are subjected to lamination, with surface 43A of first electrically conductive adhesive sheet 40 and second surface 50B of graphite film 50 disposed so as to overlap one another.

In the present exemplary embodiment, steps (1A), (1B), and (1C) are performed in this order. The present disclosure, however, is not limited to this order. As an exemplary alternative, the steps may be performed in an order of steps (1B), (1A), and (1C).

### [Step (1A)]

Step (1A) includes step (1a1) of forming metal layer 20 and first rust-proofing layer 30 to prepare first stacked body 111, step (1a2) of subjecting first stacked body 111 and first electrically conductive adhesive sheet 40 to lamination to prepare second stacked body 112, and step (1a3) of peeling protection film 10 and forming second rust-proofing layer 80 that are performed in this order. These steps prepare electrically conductive adhesive sheet-attached metal vapor-deposited film 100 including metal vapor-deposited film 110 as a stacked body of first rust-proofing layer 30, metal layer 20, and second rust-proofing layer 80 and including first electrically conductive adhesive sheet 40.

(Step (1a1))

In step (1a1), vapor deposition of a first metal is performed on first surface 10A of protection film 10 shown in FIG. 2A to form metal layer 20 shown in FIG. 2B. Then, first rust proofing is performed on first surface 20A of metal layer 20 to form first rust-proofing layer 30 shown in FIG. 2C. Step (1a1) gives, as shown in FIG. 2C, first stacked body 111 including protection film 10, metal layer 20, and first rust-proofing layer 30.

As a raw material for protection film 10, it is possible to use, for example, polyester, polyethylene terephthalate, an olefin resin, a styrene resin, a vinyl chloride resin, polycarbonate, an acrylonitrile-styrene copolymer resin (AS resin), polyacrylonitrile, a butadiene resin, an acrylonitrile-butadiene-styrene copolymer resin (ABS resin), an acrylic resin, polyacetal, polyphenylene ether, a phenol resin, an epoxy resin, a melamine resin, a urea resin, a polyimide, a polysulfide, a polyurethane, a vinyl acetate resin, a fluorine resin, an aliphatic polyamide, a synthetic rubber, an aromatic polyamide, or polyvinyl alcohol. Protection film 10 may further contain a flame retardant, an antistatic agent, an antioxidant, a metal deactivator, a plasticizer, or a lubricant as necessary. Protection film 10 preferably has a thickness ranging from 0.5 μm to 200 μm, inclusive.

Protection film 10 is preferably a releasable film. As the releasable film, it is possible to use, for example, one obtained by applying a release agent to a film. As a raw material for the film used for the releasable film, it is possible to use, for example, polyester, polyethylene terephthalate, an olefin resin, a styrene resin, a vinyl chloride resin, polycarbonate, an acrylonitrile-styrene copolymer resin (AS resin), polyacrylonitrile, a butadiene resin, an acrylonitrile-butadiene-styrene copolymer resin (ABS resin), an acrylic resin, polyacetal, polyphenylene ether, a phenol resin, an epoxy resin, a melamine resin, a urea resin, a polyimide, a polysulfide, a polyurethane, a vinyl acetate resin, a fluorine resin, an aliphatic polyamide, a synthetic rubber, an aromatic polyamide, or polyvinyl alcohol. As the release agent, it is possible to use, for example, silicone. Protection film 10 that is a releasable film facilitates peeling of protection film 10.

A method for performing the vapor deposition of the first metal is preferably vacuum vapor deposition. Treatment conditions for the vacuum vapor deposition may be appropriately adjusted according to, for example, the type of the first metal and the thickness of metal layer 20.

A method for performing the first rust proofing on first surface 20A of metal layer 20 may be appropriately adjusted as follows according to the raw material for first rust-proofing layer 30.

When first rust-proofing layer 30 is an organic coating film, examples of the method for performing the first rust proofing on first surface 20A of metal layer 20 include a method for adding an above-mentioned raw material for the organic coating film to a solvent to give a rust-proofing liquid, applying the rust-proofing liquid to first surface 20A of metal layer 20, and drying the rust-proofing liquid. An addition amount of the raw material for the organic coating film may be appropriately adjusted according to, for example, the thickness of first rust-proofing layer 30. The solvent may be appropriately adjusted according to the raw material for the organic coating film, and examples of the solvent include water and isoproprene alcohol. The rust-proofing liquid may contain another component as necessary. Examples of the other component include carboxylic anhydride. As the carboxylic anhydride, it is possible to use acetic anhydride, succinic anhydride, maleic anhydride, propionic anhydride, or phthalic anhydride. A method for applying the rust-proofing liquid is not particularly limited, and examples of the method include roller coating, roll coater coating, spin coater coating, curtain roll coater coating, slit coater coating, spray coating, and immersion coating. The rust-proofing liquid may be heated as necessary when dried.

When first rust-proofing layer 30 is a metal coating film, the method for performing the first rust proofing on first surface 20A of metal layer 20 may be appropriately adjusted according to, for example, the raw material for the metal coating film and the thickness of first rust-proofing layer 30, and examples of the method include electroplating, electroless plating, physical vapor deposition, and chemical vapor deposition. Examples of the physical vapor deposition include vacuum vapor deposition, ion plating, and sputtering. Treatment conditions for the first rust proofing may be appropriately adjusted according to, for example, the raw material for the metal coating film and the thickness of first rust-proofing layer 30.

Step (1a1) may continuously manufacture first stacked body 111 by, for example, continuously sending elongated protection film 10 out to a manufacturing step of performing the vapor deposition of the first metal and allowing the elongated protection film to go through the manufacturing step of performing the vapor deposition of the first metal and a manufacturing step of performing the first rust proofing in this order.

(Step (1a2))

In step (1a2), first electrically conductive adhesive sheet 40 is, as shown in FIG. 2D, disposed on surface 30A of first stacked body 111, thus laminating surface 30A with first electrically conductive adhesive sheet 40. At this time, second peeling sheet 120 is, as shown in FIG. 2D, fitted to surface 43A of first electrically conductive adhesive sheet 40 from a viewpoint of easy handling. Step (1a2) gives, as shown in FIG. 2E, second stacked body 112 including first stacked body 111 and first electrically conductive adhesive sheet 40.

Examples of a manufacturing method for second peeling sheet 120-fitted first electrically conductive adhesive sheet 40 shown in FIG. 2D include a method including following steps of;

applying an electrically conductive adhesive agent onto a surface of a third peeling sheet to form first adhesion layer 41;

applying an electrically conductive adhesive agent onto surface 120A of second peeling sheet 120 and drying the electrically conductive adhesive agent to form second adhesion layer 43; and

attaching first adhesion layer 41 and second adhesion layer 43 respectively to first surface 42A and second surface 42B of first metal substrate 42 having first surface 42A and second surface 42B, to form a laminated film, and curing the laminated film and then peeling the third peeling sheet from the laminated film.

Examples of a method for applying the electrically conductive adhesive agent include a method with use of, for example, a roll coater or a die coater. When the electrically conductive adhesive agent contains a solvent, the drying is preferably performed in an environment with a temperature approximately ranging from 50° C. to 120° C. to remove the solvent. As a treatment condition for the curing, a treatment temperature preferably ranges from 15° C. to 50° C., inclusive, and a treatment period preferably ranges from 48 hours to 168 hours, inclusive. Second peeling sheet 120 and the third peeling sheet have the same structure as first peeling sheet 70.

Examples of a method for subjecting first stacked body 111 and first electrically conductive adhesive sheet 40 to lamination include a method for disposing first stacked body 111 and first electrically conductive adhesive sheet 40 such that surface 30A of first stacked body 111 faces surface 41A of first electrically conductive adhesive sheet 40, and thereafter making surface 30A of first stacked body 111 adherent to surface 41A of first electrically conductive adhesive sheet 40 by pressure contact.

In step (1a2), the lamination may be performed by, for example, sending elongated first stacked body 111 and elongated first electrically conductive adhesive sheet 40 out to between a pair of rolls and sandwiching first stacked body 111 and first electrically conductive adhesive sheet 40 between the pair of rolls for surface contact.

In the present exemplary embodiment, second peeling sheet 120 is fitted to surface 43A of first electrically conductive adhesive sheet 40. The present disclosure, however, is not limited to this configuration, and second peeling sheet 120 need not be fitted to surface 43A of first electrically conductive adhesive sheet 40.

(Step (1a3))

In step (1a3), protection film 10 is peeled from second stacked body 112 as shown in FIG. 2F, and second rust proofing is performed on second surface 20B of metal layer 20 to form second rust-proofing layer 80 shown in FIG. 2G. Step (1a3) gives, as shown in FIG. 2G, electrically conductive adhesive sheet-attached metal vapor-deposited film 100 including metal vapor-deposited film 110 and first electrically conductive adhesive sheet 40.

As a method for performing the second rust proofing, it is possible to use the same method as the method for performing the first rust proofing in step (1a1) of the present exemplary embodiment.

In the present exemplary embodiment, step (1A) includes steps (1a1), (1a2), and (1a3). The present disclosure, however, is not limited to this order of the steps and may employ, for example, a method for peeling protection film 10 and forming second rust-proofing layer 80 after step (1a1) to produce metal vapor-deposited film 110 and then subjecting metal vapor-deposited film 110 and first electrically conductive adhesive sheet 40 to lamination. Alternatively, electrically conductive adhesive sheet-attached metal vapor-deposited film 100 may be produced by, for example, a method for peeling protection film 10 after step (1a1), subjecting a stacked body of metal layer 20 and first rust-proofing layer 30 and first electrically conductive adhesive sheet 40 to lamination, and then forming second rust-proofing layer 80.

### [Step (1B)]

In step (1B), second electrically conductive adhesive sheet 60 is, as shown in FIG. 4A, disposed on first surface 50A of graphite film 50 having first surface 50A and second surface 50B, thus laminating first surface 50A with second electrically conductive adhesive sheet 60. At this time, first peeling sheet 70 is, as shown in FIG. 4A, fitted to surface 63A of second electrically conductive adhesive sheet 60 from a viewpoint of easy handling. Step (1B) gives electrically conductive adhesive sheet-attached graphite film 200 shown in FIG. 4B.

Examples of a manufacturing method for first peeling sheet 70-fitted second electrically conductive adhesive sheet 60 shown in FIG. 4A include the same method as the above-mentioned manufacturing method for second peeling sheet 120-fitted first electrically conductive adhesive sheet 40 shown in FIG. 2D.

Examples of a method for subjecting graphite film 50 and second electrically conductive adhesive sheet 60 to lamination include a method for disposing second electrically conductive adhesive sheet 60 as shown in FIG. 4A such that surface 61A of second electrically conductive adhesive sheet 60 is directed upward and placing graphite film 50 that has been cut into a prescribed dimension on surface 61A of second electrically conductive adhesive sheet 60. The dimension of cut graphite film 50 may be any dimension as long as entire graphite film 50 is, as shown in FIG. 4D, covered with electrically conductive adhesive sheet-attached metal vapor-deposited film 100 and electrically conductive adhesive sheet-attached graphite film 200. Covering entire graphite film 50 with electrically conductive adhesive sheet-attached metal vapor-deposited film 100 and electrically conductive adhesive sheet-attached graphite film 200 is capable of preventing rupture of graphite composite film 1 attributed to interlayer peeling in graphite layer 50 and preventing powder dropping of graphite layer 50.

In step (1B), for example, second electrically conductive adhesive sheet GO is continuously sent out to a laminate manufacturing step, and cut graphite film 50 is continuously placed, with a prescribed interval, on surface 61A of second electrically conductive adhesive sheet 60. Thus, electrically conductive adhesive sheet-attached graphite film 200 may be manufactured continuously.

In the present exemplary embodiment, cut graphite film 50 is placed on surface 61A of second electrically conductive adhesive sheet 60, thus laminating the surface with the graphite film. The present disclosure, however, is not limited to this lamination process, and the lamination may be performed by continuously sending each of elongated graphite film 50 and elongated second electrically conductive adhesive sheet 60 out to between a pair of rolls and sandwiching graphite film 50 and second electrically conductive adhesive sheet 60 between the pair of rolls for surface contact.

### [Step (1C)]

In step (1C), electrically conductive adhesive sheet-attached metal vapor-deposited film 100 and electrically conductive adhesive sheet-attached graphite film 200 are, as shown in FIG. 4C, subjected to lamination, with surface 43A of first electrically conductive adhesive sheet 40 and second surface 50B of graphite film 50 disposed so as to overlap one another. At this time, as shown in FIG. 4C, second peeling sheet 120 has been peeled, whereas first peeling sheet 70 is kept fitted from a viewpoint of easy handling of graphite composite film 1. Step (1C) gives graphite composite film 1 shown in FIG. 4D.

Examples of a method for subjecting electrically conductive adhesive sheet-attached metal vapor-deposited film 100 and electrically conductive adhesive sheet-attached graphite film 200 to lamination include a method for disposing electrically conductive adhesive sheet-attached graphite film 200 as shown in FIG. 4C such that surface 200A on a graphite film 50-disposed side is directed upward, and thereafter placing electrically conductive adhesive sheet-attached metal vapor-deposited film 100 on surface 200A of electrically conductive adhesive sheet-attached graphite film 200 so as to cover entire graphite film 50.

In step (1C), for example, elongated electrically conductive adhesive sheet-attached metal vapor-deposited film 100 and elongated electrically conductive adhesive sheet-attached graphite film 200 are sent out to between a pair of rolls. Thereafter, the lamination is performed by sandwiching electrically conductive adhesive sheet-attached metal vapor-deposited film 100 and electrically conductive adhesive sheet-attached graphite film 200 between the pair of rolls for surface contact, and a resultant graphite composite film is cut into a necessary size. Thus, graphite composite film 1 may be manufactured continuously.

The present exemplary embodiment includes steps (1A), (1B), and (1C). The present disclosure, however, is not limited to this stacking order, and following methods are exemplified. For example, first stacked body 111, first electrically conductive adhesive sheet 40, graphite film 50, and second electrically conductive adhesive sheet 60 are simultaneously subjected to lamination, and then second rust-proofing layer 80 is formed after peeling protection film 10. Such a manufacturing method for graphite composite film 1 is exemplified. Alternatively, first electrically conductive adhesive sheet 40, graphite film 50, and second electrically conductive adhesive sheet 60 are subjected to lamination to give a laminated film, and the obtained laminated film and metal vapor-deposited film 110 are subjected to lamination. Such a manufacturing method for graphite composite film 1 is exemplified. Alternatively, metal vapor-deposited film 110, first electrically conductive adhesive sheet 40, and graphite film 50 are subjected to lamination to give a laminated film, and the obtained laminated film and second electrically conductive adhesive sheet 60 are subjected to lamination. Such a manufacturing method for graphite composite film 1 is exemplified.

### Second Exemplary Embodiment

### [Manufacturing Method for Graphite Composite Film]

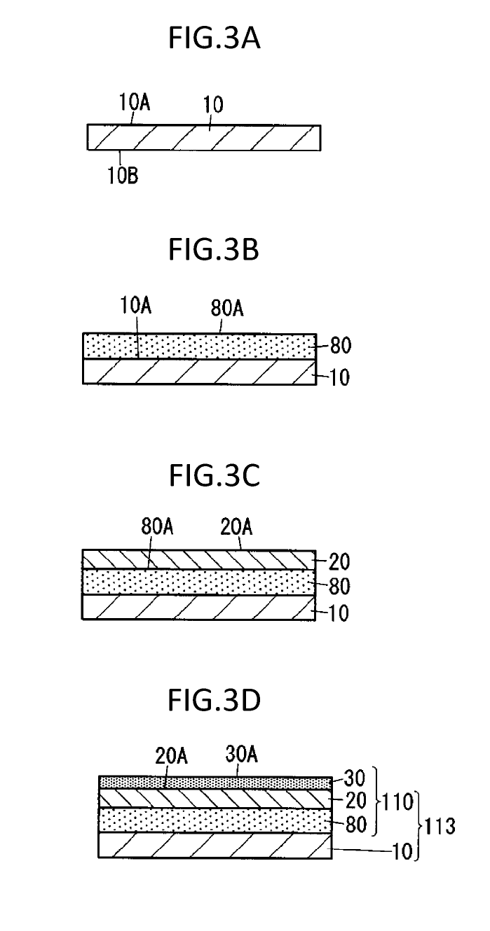

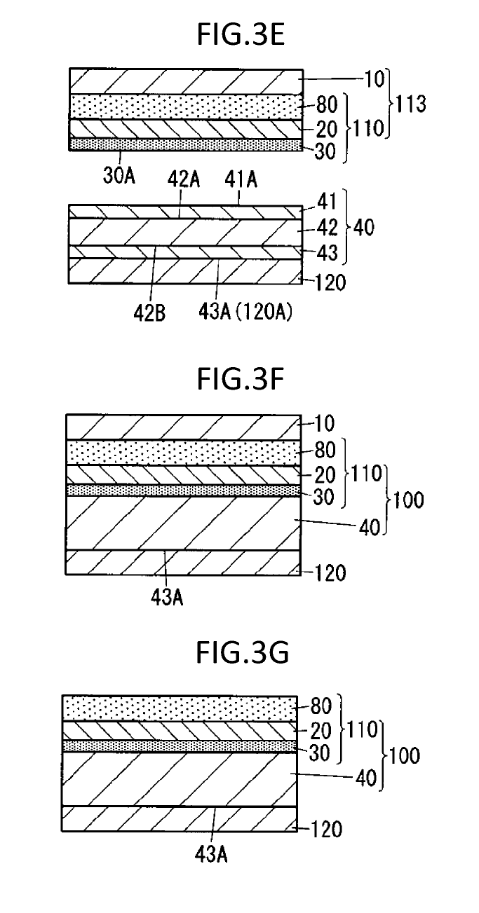

FIGS. 3A to 3G are schematic sectional views for illustrating part of a manufacturing method for graphite composite film 1 according to a second exemplary embodiment of the present disclosure. Specifically, FIGS. 3A to 3G are schematic sectional views for illustrating step (1A) of preparing electrically conductive adhesive sheet-attached metal vapor-deposited film 100.

FIGS. 4A to 4D are schematic sectional views for illustrating part of the manufacturing method for graphite composite film 1 according to the second exemplary embodiment of the present disclosure. Specifically, FIGS. 4A and 4B are schematic sectional views for illustrating step (1B) of preparing electrically conductive adhesive sheet-attached graphite film 200. FIGS. 4C and 4D are schematic sectional views for illustrating step (1C) of subjecting electrically conductive adhesive sheet-attached metal vapor-deposited film 100 and electrically conductive adhesive sheet-attached graphite film 200 to lamination. Constituent members in FIGS. 3A to 3G and 4A to 4D that are identical with the constituent members of the exemplary embodiment shown in FIG. 1A are denoted by identical reference marks and are not described. Specifically, graphite film 50 corresponds to graphite layer 50, first electrically conductive adhesive sheet 40 corresponds to first electrically conductive adhesive layer 40, and second electrically conductive adhesive sheet 60 corresponds to second electrically conductive adhesive layer 60.

The manufacturing method for graphite composite film 1 according to the second exemplary embodiment includes following steps. That is, the manufacturing method includes step (1A) of preparing electrically conductive adhesive sheet-attached metal vapor-deposited film 100, step (1B) of preparing electrically conductive adhesive sheet-attached graphite film 200, and step (1C) of subjecting electrically conductive adhesive sheet-attached metal vapor-deposited film 100 and electrically conductive adhesive sheet-attached graphite film 200 to lamination. Steps (1A), (1B), and (1C) are performed in this order. These steps give graphite composite film 1 that is capable of attaining both a measure against heat and a measure against electromagnetic noise and that is less likely to cause degradation of electromagnetic wave shielding properties.

Step (1A): vapor deposition of a second metal and a first metal is performed in this order on first surface 10A of protection film 10 having first surface 10A and second surface 10B, to form second rust-proofing layer 80 containing the second metal and metal layer 20 containing the first metal (hereinafter, step (1a1)). Rust proofing is performed on first surface 20A of metal layer 20 to form first rust-proofing layer 30 and thus prepare stacked body 113 of protection film 10 and metal vapor-deposited film 110 (hereinafter, step (1a2)). First electrically conductive adhesive sheet 40 is disposed on surface 30A of first rust-proofing layer 30 in stacked body 113, thus laminating the surface with the first electrically conductive adhesive sheet, and protection film 10 is peeled (hereinafter, step (1a3)). Thus, electrically conductive adhesive sheet-attached metal vapor-deposited film 100 is prepared that includes metal vapor-deposited film 110 and first electrically conductive adhesive sheet 40.

Step (1B): second electrically conductive adhesive sheet 60 is disposed on first surface 50A of graphite film 50 having first surface 50A and second surface 50B, thus laminating the first surface with the second electrically conductive adhesive sheet.

Step (1C): electrically conductive adhesive sheet-attached metal vapor-deposited film 100 and electrically conductive adhesive sheet-attached graphite film 200 are subjected to lamination, with surface 43A of first electrically conductive adhesive sheet 40 and second surface 50B of graphite film 50 disposed so as to overlap one another.

In the present exemplary embodiment, steps (1A), (1B), and (1C) are performed in this order. The present disclosure, however, is not limited to this order. As an exemplary alternative, the steps may be performed in an order of steps (1B), (1A), and (1C).

Steps (1B) and (1C) in the present exemplary embodiment are the same as steps (1B) and (1C) in the first exemplary embodiment and are thus not described.

### [Step (1A)]

Step (1A) includes step (1a1) of forming second rust-proofing layer 80 and metal layer 20, step (1a2) of forming first rust-proofing layer 30 to prepare stacked body 113, and step (1a3) of subjecting stacked body 113 and first electrically conductive adhesive sheet 40 to lamination and then peeling protection film 10 that are performed in this order. These steps prepare electrically conductive adhesive sheet-attached metal vapor-deposited film 100 including metal vapor-deposited film 110 as a stacked body of first rust-proofing layer 30, metal layer 20, and second rust-proofing layer 80 and including first electrically conductive adhesive sheet 40.

(Step (1a1))

In step (1a1), vapor deposition of a second metal is performed on first surface 10A of protection film 10 shown in FIG. 3A to form second rust-proofing layer 80 shown in FIG. 3B. Then, vapor deposition of a first metal is performed on surface 80A of second rust-proofing layer 80 to form metal layer 20 shown in FIG. 3C.

Protection film 10 used in the present exemplary embodiment may be the same as protection film 10 used in the first exemplary embodiment.

A method for performing the vapor deposition of the first metal is preferably vacuum vapor deposition. Treatment conditions for the vacuum vapor deposition may be appropriately adjusted according to, for example, the type of the first metal and the thickness of metal layer 20.

A method for performing the vapor deposition of the second metal may be appropriately adjusted according to, for example, the type of the second metal and the thickness of second rust-proofing layer 80, and examples of the method include electroplating, electroless plating, physical vapor deposition, and chemical vapor deposition. Examples of the physical vapor deposition include vacuum vapor deposition, ion plating, and sputtering. The method for performing the vapor deposition of the second metal is preferably vacuum vapor deposition. Treatment conditions for the vacuum vapor deposition may be appropriately adjusted according to, for example, the type of the second metal and the thickness of second rust-proofing layer 80.

Step (1a1) may continuously manufacture second rust-proofing layer 80 and metal layer 20 by, for example, continuously sending elongated protection film 10 out to a manufacturing step of performing the vapor deposition of the second metal and allowing the elongated protection film to go through the manufacturing step of performing the vapor deposition of the second metal and a manufacturing step of performing the vapor deposition of the first metal in this order.

(Step (1a2))

In step (1a2), rust proofing is performed on first surface 20A of metal layer 20 to form first rust-proofing layer 30 shown in FIG. 3D. Step (1a2) gives, as shown in FIG. 3D, stacked body 113 including protection film 10 and metal vapor-deposited film 110.

As a method for performing the rust proofing on first surface 20A of metal layer 20 in step (1a2) of the present exemplary embodiment, it is possible to use the same method as the method for performing the first rust proofing in step (1a1) of the first exemplary embodiment.

It is possible to perform step (1a2) continuously to step (1a1) by, for example, allowing the elongated protection film to go through continuous manufacturing step (1a1), followed by the step of forming the first rust-proofing layer.

(Step (1a3))

In step (1a3), first electrically conductive adhesive sheet 40 is disposed on surface 30A of first rust-proofing layer 30 in stacked body 113, thus laminating surface 30A with first electrically conductive adhesive sheet 40. At this time, second peeling sheet 120 is, as shown in FIG. 3E, fitted to surface 43A of first electrically conductive adhesive sheet 40 from a viewpoint of easy handling. Thereafter, protection film 10 is peeled, and electrically conductive adhesive sheet-attached metal vapor-deposited film 100 shown in FIG. 3G is obtained that includes metal vapor-deposited film 110 and first electrically conductive adhesive sheet 40.

A manufacturing method for second peeling sheet 120-fitted first electrically conductive adhesive sheet 40 shown in FIG. 3E may be the same as the manufacturing method for first electrically conductive adhesive sheet 40 shown in FIG. 2D.

Examples of a method for subjecting stacked body 113 and first electrically conductive adhesive sheet 40 to lamination include a method for disposing stacked body 113 and first electrically conductive adhesive sheet 40 such that surface 30A of stacked body 113 faces surface 41A of first electrically conductive adhesive sheet 40, and thereafter making surface 30A of stacked body 113 adherent to surface 41A of first electrically conductive adhesive sheet 40 by pressure contact.

In step (1a3), the lamination may be performed by, for example, sending stacked body 113 and elongated first electrically conductive adhesive sheet 40 out to between a pair of rolls and sandwiching stacked body 113 and first electrically conductive adhesive sheet 40 between the pair of rolls for surface contact.

In the present exemplary embodiment, second peeling sheet 120 is fitted to surface 43A of first electrically conductive adhesive sheet 40. The present disclosure, however, is not limited to this configuration, and second peeling sheet 120 need not be fitted to surface 43A of first electrically conductive adhesive sheet 40.

In the present exemplary embodiment, step (1A) includes steps (1a1), (1a2), and (1a3). The present disclosure, however, is not limited to this order of the steps. For example, the present disclosure may employ a method for peeling protection film 10 from stacked body 113 after steps (1a1) and (1a2) to produce metal vapor-deposited film 110 and then subjecting metal vapor-deposited film 110 and first electrically conductive adhesive sheet 40 to lamination. Alternatively, protection film 10 is peeled after step (1a1), and first rust-proofing layer 30 is formed by step (1a2). Thereafter, electrically conductive adhesive sheet-attached metal vapor-deposited film 100 may be produced by, for example, a method for subjecting metal vapor-deposited film 110 and first electrically conductive adhesive sheet 40 to lamination.

The present exemplary embodiment includes steps (1A), (1B), and (1C). The present disclosure, however, is not limited to this stacking order, and following methods are exemplified. For example, stacked body 113, first electrically conductive adhesive sheet 40, graphite film 50, and second electrically conductive adhesive sheet 60 are simultaneously subjected to lamination, and then protection film 10 is peeled. Such a manufacturing method for graphite composite film 1 is exemplified. Alternatively, first electrically conductive adhesive sheet 40, graphite film 50, and second electrically conductive adhesive sheet 60 are subjected to lamination to give a laminated film, and the obtained laminated film and metal vapor-deposited film 110 are subjected to lamination. Such a manufacturing method for graphite composite film 1 is exemplified. Alternatively, metal vapor-deposited film 110, first electrically conductive adhesive sheet 40, and graphite film 50 are subjected to lamination to give a laminated film, and the obtained laminated film and second electrically conductive adhesive sheet 60 are subjected to lamination. Such a manufacturing method for graphite composite film 1 is exemplified.

Hereinafter, the present disclosure is specifically described with reference to examples.

### Example 1

### [Step (1A)]

(Step (1a1))

As protection film 10, a polyester film (“CX40” manufactured by Toray Industries, Inc., main raw material: PET, thickness: 6 μm) was prepared. Vacuum vapor deposition of copper (oxygen-free copper manufactured by Hitachi Metals Neomaterial, Ltd.) as the first metal was performed on first surface 10A of protection film 10 to form metal layer 20 (thickness: 1 μm) shown in FIG. 2B. Next, a rust-proofing agent (CI guard “GW-172P” manufactured by TOEI KASEI CO., LTD.) was applied to first surface 20A of metal layer 20 by roller coating and dried to form first rust-proofing layer 30 (thickness: 4 nm) shown in FIG. 2C. These procedures gave first stacked body 111 shown in FIG. 2C.

(Step (1a2))

As second peeling sheet 120-fitted first electrically conductive adhesive sheet 40, a sheet was prepared that was obtained by peeling a peeling sheet from one surface 41A of an electrically conductive double coated adhesive sheet (DAITAC (registered trademark) “#8506ADW-10-H2” manufactured by DIC Corporation, metal substrate: substrate formed of aluminum, thickness: 10 μm).

As shown in FIG. 2D, first stacked body 111 and first electrically conductive adhesive sheet 40 were disposed such that surface 30A of first stacked body 111 faced surface 41A of first electrically conductive adhesive sheet 40. Then, surface 30A of first stacked body 111 was made adherent to surface 41A of first electrically conductive adhesive sheet 40 by pressure contact. These procedures gave second stacked body 112 shown in FIG. 2E.

(Step (1a3))

The polyester film as protection film 10 was peeled from second stacked body 112 by pressing a peeling roller against the polyester film. Next, a rust-proofing agent (CI guard “GW-172P” manufactured by TOEI KASEI CO., LTD.) was applied to second surface 20B of metal layer 20 by roller coating and dried to form second rust-proofing layer 80 (thickness: 4 nm) shown in FIG. 2G. These procedures gave electrically conductive adhesive sheet-attached metal vapor-deposited film 100 shown in FIG. 2G.

### [Step (1B)]

As first peeling sheet 70-fitted second electrically conductive adhesive sheet 60, a sheet was prepared that was obtained by peeling a peeling sheet from one surface 61A from an electrically conductive double coated adhesive sheet, i.e., the same product as first electrically conductive adhesive sheet 40. As graphite film 50, a graphite film (“PGS (registered trademark) graphite sheet” manufactured by Panasonic Corporation, thickness: 25 μm) cut into a size of 10 cm×12 cm was prepared.

As shown in FIG. 4A, second electrically conductive adhesive sheet 60 was disposed such that surface 61A of second electrically conductive adhesive sheet 60 was directed upward, and graphite film 50 was placed on surface 61A of second electrically conductive adhesive sheet 60. These procedures gave electrically conductive adhesive sheet-attached graphite film 200 shown in FIG. 4B.

### [Step (1C)]

As shown in FIG. 4C, electrically conductive adhesive sheet-attached graphite film 200 was disposed such that surface 200A on a graphite film 50-disposed side was directed upward. Then, electrically conductive adhesive sheet-attached metal vapor-deposited film 100 was placed on surface 200A of electrically conductive adhesive sheet-attached graphite film 200 so as to cover entire graphite film 50 and was cut into a size of 10 cm×12 cm. These procedures gave graphite composite film 1 shown in FIG. 4D.

### Example 2

(Step (1a1))

As protection film 10, a polyester film (“CX40” manufactured by Toray Industries, Inc., main raw material: PET, thickness: 6 μm) was prepared. Vacuum vapor deposition of nickel (electrolytic nickel manufactured by Sumitomo Metal Mining Co., Ltd.) as the second metal was performed on first surface 10A of protection film 10 to form second rust-proofing layer 80 (thickness: 40 nm) shown in FIG. 3B. Next, vacuum vapor deposition of copper (oxygen-free copper manufactured by Hitachi Metals Neomaterial, Ltd.) as the first metal was performed on surface 80A of second rust-proofing layer 80 to form metal layer 20 (thickness: 1 μm) shown in FIG. 3C.

(Step (1a2))

A rust-proofing agent (CI guard “GW-172P” manufactured by TOEI KASEI CO., LTD.) was applied to first surface 20A of metal layer 20 by roller coating and dried to form first rust-proofing layer 30 (thickness: 4 nm) shown in FIG. 3D. These procedures gave stacked body 113 shown in FIG. 3D.

(Step (1a3))

As second peeling sheet 120-fitted first electrically conductive adhesive sheet 40, a sheet was prepared that was obtained by peeling a peeling sheet from one surface 41A of an electrically conductive double coated adhesive sheet (DAITAC (registered trademark) “#8506ADW-10-112” manufactured by DIC Corporation, metal substrate: substrate formed of aluminum, thickness: 10 μm).

As shown in FIG. 3E, stacked body 113 and first electrically conductive adhesive sheet 40 were disposed such that surface 30A of stacked body 113 faced surface 41A of first electrically conductive adhesive sheet 40. Then, surface 30A of stacked body 113 was made adherent to surface 41A of first electrically conductive adhesive sheet 40 by pressure contact. Next, the polyester film as protection film 10 was peeled by pressing a peeling roller against the polyester film. These procedures gave electrically conductive adhesive sheet-attached metal vapor-deposited film 100 shown in FIG. 3G.

### [Step (1B)]

As first peeling sheet 70-fitted second electrically conductive adhesive sheet 60, a sheet was prepared that was obtained by peeling a peeling sheet from one surface 61A from an electrically conductive double coated adhesive sheet, i.e., the same product as first electrically conductive adhesive sheet 40. As graphite film 50, a graphite film (“PGS (registered trademark) graphite sheet” manufactured by Panasonic Corporation, thickness: 25 μm) cut into a size of 10 cm×12 cm was prepared.

As shown in FIG. 4A, second electrically conductive adhesive sheet 60 was disposed such that surface 61A of second electrically conductive adhesive sheet 60 was directed upward, and graphite film 50 was placed on surface 61A of second electrically conductive adhesive sheet 60. These procedures gave electrically conductive adhesive sheet-attached graphite film 200 shown in FIG. 4B.

### [Step (1C)]

As shown in FIG. 4C, electrically conductive adhesive sheet-attached graphite film 200 was disposed such that surface 200A on a graphite film 50-disposed side was directed upward. Then, electrically conductive adhesive sheet-attached metal vapor-deposited film 100 was placed on surface 200A of electrically conductive adhesive sheet-attached graphite film 200 so as to cover entire graphite film 50 and was cut into a size of 10 cm×12 cm. These procedures gave graphite composite film 1 shown in FIG. 4D.

### Comparative Example 1

### [Step (1A)]

(Step (1a1))

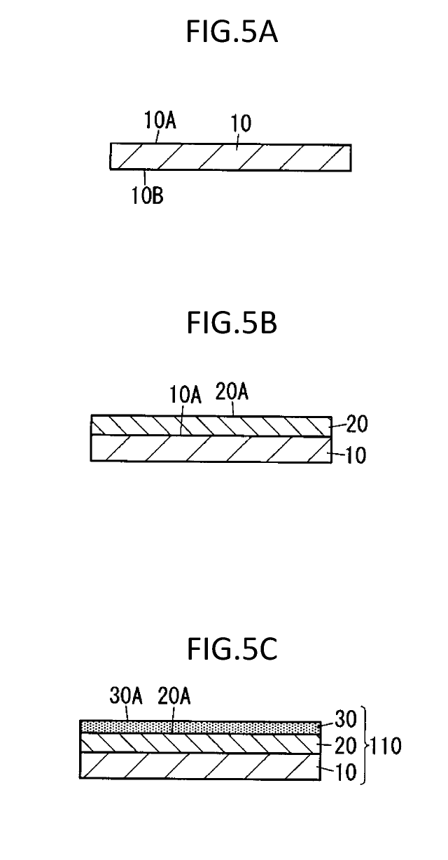

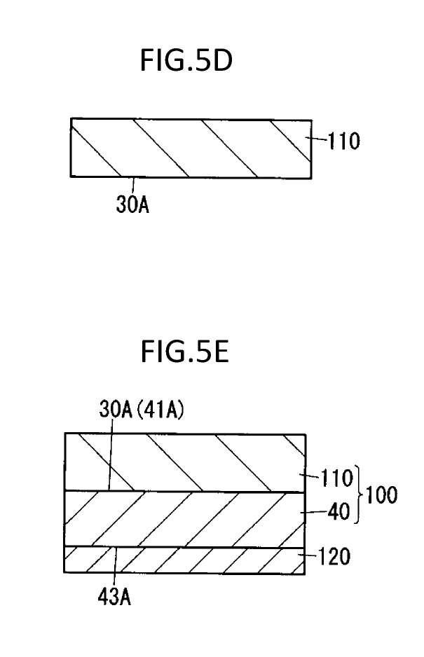

As protection film 10 shown in FIG. 5A, a polyester film (“CX40” manufactured by Toray Industries, Inc., main raw material: PET, thickness: 6 μm) was prepared. Vacuum vapor deposition of copper (oxygen-free copper manufactured by Hitachi Metals Neomaterial, Ltd.) as the first metal was performed on first surface 10A of protection film 10 to form metal layer 20 (thickness: 1 μm) shown in FIG. 5B. Next, a rust-proofing agent (CI guard “GW-172P” manufactured by TOEI KASEI CO., LTD.) was applied to first surface 20A of metal layer 20 by roller coating and dried to form rust-proofing layer 30 (thickness: 4 nm) shown in FIG. 5C. These procedures gave metal vapor-deposited film 110 shown in FIG. 5C.

(Step (1a2))

As second peeling sheet 120-fitted first electrically conductive adhesive sheet 40, a sheet was prepared that was obtained by peeling a peeling sheet from one surface 41A of an electrically conductive double coated adhesive sheet DAITAC (registered trademark) “#8506ADW-10-H2” manufactured by DIC Corporation, metal substrate: substrate formed of aluminum, thickness: 10 μm).

As shown in FIG. 5D, metal vapor-deposited film 110 and first electrically conductive adhesive sheet 40 were disposed such that surface 30A of metal vapor-deposited film 110 faced surface 41A of first electrically conductive adhesive sheet 40. Then, surface 30A of metal vapor-deposited film 110 was made adherent to surface 41A of first electrically conductive adhesive sheet 40 by pressure contact. These procedures gave electrically conductive adhesive sheet-attached metal vapor-deposited film 100 shown in FIG. 5E.

### [Step (1B)]

As first peeling sheet 70-fitted second electrically conductive adhesive sheet 60, a sheet was prepared that was obtained by peeling a peeling sheet from one surface 61A from an electrically conductive double coated adhesive sheet, i.e., the same product as first electrically conductive adhesive sheet 40. As graphite film 50, a graphite film (“PGS (registered trademark) graphite sheet” manufactured by Panasonic Corporation, thickness: 25 μm) cut into a size of 10 cm×12 cm was prepared.

As shown in FIG. 4A, second electrically conductive adhesive sheet 60 was disposed such that surface 61A of second electrically conductive adhesive sheet 60 was directed upward, and graphite film 50 was placed on surface 61A of second electrically conductive adhesive sheet 60. These procedures gave electrically conductive adhesive sheet-attached graphite film 200 shown in FIG. 4B.

### [Step (1C)]

As shown in FIG. 4C, electrically conductive adhesive sheet-attached graphite film 200 was disposed such that surface 200A on a graphite film 50-disposed side was directed upward. Then, electrically conductive adhesive sheet-attached metal vapor-deposited film 100 was placed on surface 200A of electrically conductive adhesive sheet-attached graphite film 200 so as to cover entire graphite film 50 and was cut into a size of 10 cm×12 cm. These procedures gave graphite composite film 1 shown in FIG. 4D.

### Comparative Example 2

Graphite composite film 1 was obtained in the same manner as in Comparative Example 1 except that first rust-proofing layer 30 was not formed in step (1a1).

### [Test for Electromagnetic Wave Shielding Properties]

First peeling sheet 70 was peeled from obtained graphite composite film 1, and surface 1A of graphite composite film 1 was made adherent to a surface of an object by pressure contact to give sample 1. Sample 1 was subjected to an exposure treatment under exposure conditions of 40° C., 95% RH, and 250 hours to give sample 2 for graphite composite film 1 of each of Examples 1 and 2 and Comparative Examples 1 and 2.

Sample 3 was obtained in the same manner as sample 2 except that a temperature was set at 105° C. in the exposure treatment.

### [Measurement of Electromagnetic Wave Shielding Properties]

Samples 1, 2, and 3 peeled from the object were measured for electric field shielding performance and magnetic field shielding performance at a frequency range of 500 MHz in accordance with a KEC method of KEC Electronic Industry Development Center.

Table 1 shows measurement results of the electric field shielding performance and the magnetic field shielding performance of samples 1, 2, and 3.

TABLE 1

| | With or | With or | | | | |
|---|---|---|---|---|---|---|
| | without | without | | | Electric field | Magnetic field |
| | first rust- | second rust- | | Exposure | shielding | shielding |
| | proofing | proofing | | treatment | performance | performance |
| | layer 30 | layer 80 | Sample | conditions | (500 MHz) | (500 MHz) |
| Example 1 | With | With | Sample 1 | Without | 82 dB | 57 dB |
| | | | Sample 2 | 40° C., 95% RH, | 78 dB | 53 db |
| | | | | 250 hours | | |
| | | | Sample 3 | 105° C., 250 hours | 72 dB | 54 dB |
| Example 2 | With | With | Sample 1 | Without | 82 dB | 58 dB |
| | | | Sample 2 | 40° C., 95% RH, | 80 dB | 56 dB |
| | | | | 250 hours | | |
| | | | Sample 3 | 105° C., 250 hours | 72 dB | 55 dB |
| Comparative | With | Without | Sample 1 | Without | 82 dB | 57 dB |
| Example 1 | | | Sample 2 | 40° C., 95% RH, | 77 dB | 52 dB |
| | | | | 250 hours | | |
| | | | Sample 3 | 105° C., 250 hours | 71 dB | 54 dB |
| Comparative | Without | Without | Sample 1 | Without | 82 dB | 53 dR |
| Example 2 | | | Sample 2 | 40° C., 95% RH, | 57 dB | 40 dB |
| | | | | 250 hours | | |
| | | | Sample 3 | 105° C., 250 hours | 64 dB | 48 dB |

### Third Exemplary Embodiment

### [Graphite Composite Film 1]

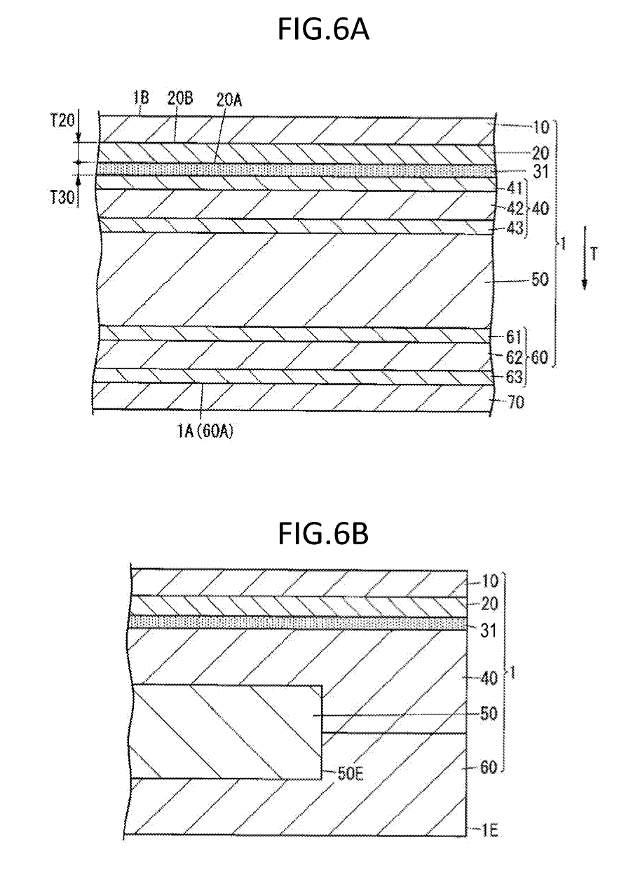

FIG. 6A is a schematic sectional view of a main portion of graphite composite film 1 according to the present exemplary embodiment. FIG. 6B is a schematic sectional view of an end portion of graphite composite film 1.

Graphite composite film 1 according to the present exemplary embodiment includes, as shown in FIG. 6A, second electrically conductive adhesive layer 60, graphite layer 50, first electrically conductive adhesive layer 40, metal layer 20, protection film 10, and rust-proofing layer 31. Metal layer 20 contains a first metal. Second electrically conductive adhesive layer 60, graphite layer 50, first electrically conductive adhesive layer 40, metal layer 20, and protection film 10 are stacked in this order. Rust-proofing layer 31 is interposed between first electrically conductive adhesive layer 40 and metal layer 20. Further, first peeling sheet 70 is fitted to surface 60A of second electrically conductive adhesive layer 60.

Graphite composite film 1 structured as described above is capable of attaining both a measure against heat and a measure against electromagnetic noise of an electromagnetic device only by being attached to an object. That is, graphite composite film 1 that includes graphite layer 50 having excellent thermal conductivity is capable of dissipating heat of the object in a plane direction of graphite composite film 1 to decrease a temperature of the object. The plane direction refers to a direction perpendicular to a thickness direction of graphite layer 50. Graphite composite film 1 that includes metal layer 20 is capable of reflecting an electromagnetic wave having reached metal layer 20. This phenomenon is supposed to be caused because an electromagnetic wave having reached metal layer 20 generates eddy current in metal layer 20 by electromagnetic induction and the eddy current reflects the electromagnetic wave. Particularly, when the object has electric conductivity, metal layer 20 is electrically connected to the object and is thus earthed, so that the eddy current generated in metal layer 20 is released (grounded) to the object, resulting in the graphite composite film exhibiting more excellent electromagnetic wave shielding properties.

Further, rust-proofing layer 31 interposed between first electrically conductive adhesive layer 40 and metal layer 20 makes first surface 20A on a rust-proofing layer 31-disposed side of metal layer 20 less likely to be discolored (hereinafter, corrosion) and the electromagnetic wave shielding properties less likely to be degraded. This phenomenon is supposed to be caused because rust-proofing layer 31 suppresses progress of the corrosion of metal layer 20 to make sheet resistance of metal layer 20 less likely to rise over time and energy of generated eddy current less likely to be converted to thermal energy.

In end surface 1E of graphite composite film 1, end surface 50E of graphite layer 50 is not exposed as shown in FIG. 6B. That is, end surface 50E of graphite layer 50 is covered with first electrically conductive adhesive layer 40 and second electrically conductive adhesive layer 60. This configuration is capable of preventing both rupture of graphite composite film 1 attributed to interlayer peeling in graphite layer 50 and powder dropping of graphite layer 50.

Graphite composite film 1 preferably has a thickness ranging from 15 μm to 800 μm, inclusive. It is possible to measure the thickness of graphite composite film 1 based on an image obtained by observing a section of graphite composite film 1 with a scanning electron microscope (SEM). It is also possible to similarly measure thicknesses of following layers forming graphite composite film 1.

It is possible to use graphite composite film 1 by, for example, peeling first peeling sheet 70 from graphite composite film 1 just before use and attaching the graphite composite film to an object. Examples of the object include an electronic component disposed within a housing of an electronic device. Examples of the electronic component include a rear chassis of a liquid crystal unit, a light-emitting diode (LED) substrate having a light-emitting diode (LED) light source used as, for example, a back light of a liquid crystal image display device, a power amplifier, and a large scale integrated circuit (LSI). As first peeling sheet 70, it is possible to use, for example, one obtained by performing, with, for example, a silicone resin, a peeling treatment on one or both surfaces of paper, a resin film, laminated paper obtained by stacking paper and a resin film, or paper filled with, for example, clay or polyvinyl alcohol. Here, examples of the paper include kraft paper, glassine paper, and pure paper. Examples of the resin film include polyethylene, polypropylene (OPP, CPP), and polyethylene terephthalate (PET).

Graphite composite film 1 according to the present exemplary embodiment has a structure including second electrically conductive adhesive layer 60, graphite layer 50, first electrically conductive adhesive layer 40, rust-proofing layer 31, metal layer 20, and protection film 10 stacked in this order. The present disclosure, however, is not limited to this structure, and the graphite composite film may have any structure as long as graphite layer 50, first electrically conductive adhesive layer 40, rust-proofing layer 31, metal layer 20, and protection film 10 are disposed in this order, and a layer that does not inhibit the effects of the present disclosure may be stacked between these layers. In the present exemplary embodiment, end surface 50E of graphite layer 50 is covered with first electrically conductive adhesive layer 40 and second electrically conductive adhesive layer 60. The present disclosure, however, is not limited to this configuration, and end surface 50E of graphite layer 50 may be exposed. In the present exemplary embodiment, an end surface of metal layer 20 is exposed as shown in FIG. 6B. The present disclosure, however, is not limited to this configuration, and the end surface of metal layer 20 may be covered with protection film 10. The end surface of metal layer 20 that is covered with protection film 10 is less likely to be corroded and thus makes the electromagnetic wave shielding properties of graphite composite film 1 further less likely to be degraded.

### (Protection Film 10)

Graphite composite film 1 includes protection film 10. This configuration is capable of suppressing progress of oxidation on second surface 20B on a protection film 10-disposed side of metal layer 20 and preventing a flaw on second surface 20B of metal layer 20. Further, it is possible to impart electrical insulating properties on surface 1B of graphite composite film 1.

As a raw material for protection film 10, it is possible to use, for example, polyester, polyethylene terephthalate, an olefin resin, a styrene resin, a vinyl chloride resin, polycarbonate, an acrylonitrile-styrene copolymer resin (AS resin), polyacrylonitrile, a butadiene resin, an acrylonitrile-butadiene-styrene copolymer resin (ABS resin), an acrylic resin, polyacetal, polyphenylene ether, a phenol resin, an epoxy resin, a melamine resin, a urea resin, a polyimide, a polysulfide, a polyurethane, a vinyl acetate resin, a fluorine resin, an aliphatic polyamide, a synthetic rubber, an aromatic polyamide, or polyvinyl alcohol. Protection film 10 may further contain a flame retardant, an antistatic agent, an antioxidant, a metal deactivator, a plasticizer, or a lubricant as necessary. Protection film 10 preferably has a thickness ranging from 0.5 μm to 200 μm, inclusive.

Protection film 10 has a solid form as a surface form when viewed in thickness direction T of graphite composite film 1. That is, protection film 10 is provided without a gap over a whole region of a surface of graphite composite film 1 and metal layer 20 is not exposed, when viewed in thickness direction. T of graphite composite film 1.

### (Metal Layer 20)

Graphite composite film 1 includes metal layer 20. This configuration makes graphite composite film 1 have the electromagnetic wave shielding properties.

Metal layer 20 contains a first metal. The first metal may be appropriately selected according to a raw material for graphite composite film 1, and it is possible to use, for example, silver, copper, gold, aluminum, magnesium, tungsten, cobalt, zinc, nickel, brass, potassium, lithium, iron, platinum, tin, chromium, lead, or titanium. Among these metals, the first metal is preferably a raw material having a low volume specific resistance in a raw material for graphite composite film 1, more preferably copper. This is because such a first metal has an advantage of improving the electromagnetic wave shielding properties of graphite composite film 1.

Metal layer 20 has a thickness ranging preferably from 0.10 μm to 5.00 μm, inclusive, more preferably from 0.50 μm to 2.00 μm, inclusive.

In the present exemplary embodiment, metal layer 20 has a solid form as a surface form when viewed in thickness direction T of graphite composite film 1. The present disclosure, however, is not limited to this form. Exemplary alternatives of the surface form include a mesh form and a wire form.

### (Rust-Proofing Layer 31)

Graphite composite film 1 includes rust-proofing layer 31. Rust-proofing layer 31 is interposed between first electrically conductive adhesive layer 40 and metal layer 20. This configuration makes first surface 20A of metal layer 20 less likely to be corroded. This phenomenon is supposed to be caused because rust-proofing layer 31 makes, for example, components such as moisture and oxygen mainly contained in first electrically conductive adhesive layer 40 less likely to reach the surface of metal layer 20 and thus an electrochemical reaction between the raw material for metal layer 20 and the components in first electrically conductive adhesive layer 40 less likely to progress.

As rust-proofing layer 31, it is possible to use, for example, an organic coating film or a metal coating film.

The organic coating film may be appropriately adjusted according to the raw material for metal layer 20, and examples of the organic coating film include a benzotriazole coating film, a triazine amine coating film, a mercapto benzimidazole coating film, a thiodipropionic acid ester coating film, and a benzimidazole coating film. Among these organic coating films, when the first metal is copper, the organic coating film is preferably a benzotriazole coating film. The benzotriazole coating film as the organic coating film makes metal layer 20 formed of copper less likely to be corroded.

The benzotriazole coating film is supposed to be a polymer complex coating film of mainly a copper ion and a benzotriazole anion or a benzotriazole derivative anion. As a raw material for the benzotriazole coating film, it is possible to use, for example, benzotriazole or a benzotriazole derivative. As the benzotriazole derivative, it is possible to use, for example, benzotriazole, 2-(5-methyl-2-hydroxyphenyl)benzotriazole, 1,2,3-benzotriazole, or 2-[2-hydroxy-3,5-bis(α,α-dimethylbenzyl)phenyl]-2H-benzotriazole. As a raw material for the triazine amine coating film, it is possible to use, for example, 2,4-diamino-6-[2′-methylimidazolyl-(1′)]-ethyl-s-triazine. As a raw material for the mercapto benzimidazole coating film, it is possible to use, for example, 2-mercaptobenzimidazole, 2-mercapto-5-methylbenzimidazole, or 2-mercapto-5-methoxybenzimidazole. As a raw material for the thiodipropionic acid ester coating film, it is possible to use, for example, distearyl-3,3′-thiodipropionate or dilauryl-3,3′-thiodipropionate. As a raw material for the benzimidazole coating film, it is possible to use, for example, 2-methylbenzimidazole, 5-methylbenzimidazole, 1-hydroxy-5-methoxy-2-methylbenzimidazole-3-oxide, or 2-aminobenzimidazole.

As a raw material for the metal coating film, it is possible to use, for example, a pure metal such as zinc, nickel, chromium, titanium, aluminum, gold, silver, or palladium; or an alloy containing these pure metals. Among these metals, when the first metal is copper, the metal coating film preferably contains, as a second metal, at least one selected from the group consisting of zinc, nickel, chromium, titanium, aluminum, gold, silver, palladium, and an alloy of these metals. When the metal coating film is formed of the second metal, metal layer 20 formed of copper is less likely to be corroded.

Rust-proofing layer 31 preferably has thickness T30 of less than or equal to thickness T20 of metal layer 20. This configuration enables graphite composite film 1 to both secure flexibility and reduce weight. Specifically, rust-proofing layer 31 has thickness T30 ranging preferably from 0.002 μm to 0.100 μm, inclusive, more preferably from 0.002 μm to 0.040 μm, inclusive. Rust-proofing layer 31 has a solid form as a surface form when viewed in thickness direction T of graphite composite film 1.

### (First Electrically Conductive Adhesive Layer 40)

Graphite composite film 1 includes first electrically conductive adhesive layer 40. This configuration enables rust-proofing layer 31 to be both adhesively fixed and electrically connected to graphite layer 50.

First electrically conductive adhesive layer 40 has a structure including, as shown in FIG. 6A, first adhesion layer 41, first metal substrate 42, and second adhesion layer 43 stacked in this order. First electrically conductive adhesive layer 40 that includes first metal substrate 42 has excellent electric conductivity. First electrically conductive adhesive layer 40 preferably has a thickness ranging from 2 μm to 300 μm, inclusive. First electrically conductive adhesive layer 40 has a solid form as a surface form when viewed in thickness direction T of graphite composite film 1.

First adhesion layer 41 is formed of electrically conductive adhesive agent having electric conductivity and adhesion. The electrically conductive adhesive agent contains, for example, a polymer and an electrically conductive filler and may further contain a crosslinking agent, an additive, or a solvent as necessary. As the polymer, it is possible to use, for example, an acrylic polymer, a rubber polymer, a silicone polymer, or a urethane polymer. Among these polymers, an acrylic polymer and a rubber polymer are preferably used. This is because when graphite composite film 1 is attached to a heat generating member, peeling by an influence of heat is less likely to occur. As the acrylic polymer, it is possible to use one obtained by polymerizing a vinyl monomer such as a (meth)acrylic monomer. As the electrically conductive filler, it is possible to use, for example, a metal filler, a carbon filler, a metal composite filler, a metal oxide filler, or a potassium titanate filler. Examples of a raw material for the metal filler include silver, nickel, copper, tin, aluminum, and stainless steel. As a raw material for the carbon filler, it is possible to use, for example, Ketjen black, acetylene black, or graphite. As a raw material for the metal composite filler, it is possible to use, for example, aluminum-coated glass, nickel-coated glass, silver-coated glass, or nickel-coated carbon. As a raw material for the metal oxide filler, it is possible to use, for example, antimony-doped tin oxide, tin-doped indium oxide, or aluminum-doped zinc oxide. A shape of the electrically conductive filler is not particularly limited, and examples of the shape include powder, flakes, and fibers. As the crosslinking agent, it is possible to use, for example, an isocyanate crosslinking agent, an epoxy crosslinking agent, a chelate crosslinking agent, or an aziridine crosslinking agent. As the additive, it is possible to use a resin having adhesiveness for a purpose of further improving adhesive power of first adhesion layer 41. As the resin, it is possible to use, for example, a rosin resin, a terpene resin, an aliphatic (C5) or aromatic (C9) petroleum resin, a styrene resin, a phenolic resin, a xylene resin, or a methacrylic resin. First adhesion layer 41 has a thickness ranging preferably from 0.2 μm to 50 μm, inclusive, more preferably from 2 μm to 20 μm, inclusive.

As a raw material for first metal substrate 42, it is possible to use, for example, gold, silver, copper, aluminum, nickel, iron, tin, or an alloy of these metals. Among these metals, the raw material for first metal substrate 42 is preferably aluminum or copper. This is because aluminum or copper is excellent from viewpoints of flexibility and thermal and electric conductivity. The raw material for first metal substrate 42 is further preferably aluminum. This is because aluminum has an advantage of, for example, being less likely to promote corrosion by metal passivation. As the metal substrate formed of aluminum, it is possible to use a hard aluminum substrate formed of hard aluminum or a soft aluminum substrate formed of soft aluminum. The hard aluminum substrate is formed of aluminum foil obtained by subjecting aluminum to rolling. The soft aluminum substrate is formed of aluminum foil obtained by subjecting aluminum to rolling and annealing. As the metal substrate formed of copper, it is possible to use, for example, a substrate formed of electrolytic copper or a substrate formed of rolled copper. First metal substrate 42 has a thickness of preferably less than or equal to 200 μm, more preferably less than or equal to 100 μm.

Second adhesion layer 43 has electric conductivity and adhesion and contains, for example, a polymer and an electrically conductive filler. Second adhesion layer 43 has the same composition as first adhesion layer 41.

In the present exemplary embodiment, first electrically conductive adhesive layer 40 has a structure including, as shown in FIG. 6A, first adhesion layer 41, first metal substrate 42, and second adhesion layer 43 stacked in this order. The present disclosure, however, is not limited to this structure. As an exemplary alternative, first electrically conductive adhesive layer 40 may be a single layer formed of an electrically conductive resin. In the present exemplary embodiment, second adhesion layer 43 has the same composition as first adhesion layer 41. The present disclosure, however, is not limited to this configuration, and the second adhesion layer may have a different composition from the composition of first adhesion layer 41 as long as the second adhesion layer has electric conductivity and adhesion.

### (Graphite Layer 50)

Graphite composite film 1 includes graphite layer 50. This configuration enables graphite composite film 1 to both efficiently conduct and dissipate heat of an object should be attached the graphite composite film 1 and improve the electromagnetic wave shielding properties.

Graphite layer 50 has excellent electric conductivity and thermal conductivity in the plane direction. As a raw material for graphite layer 50, it is possible to use, for example, a layered carbon crystal graphite or a graphite intercalation compound formed through penetration of a chemical species between layers of graphite as a matrix. Examples of the chemical species include potassium, lithium, bromine, nitric acid, iron(III) chloride, tungsten hexachloride, and arsenic pentafluoride. Graphite layer 50 may be, for example, one obtained by stacking one or a plurality of graphite films. As the graphite film, it is possible to use, for example, a pyrolytic graphite sheet produced by firing a polymer film at high temperature or an expanded graphite sheet produced by an expanded graphite method. Among these graphite sheets, it is preferable to use, as the graphite film, a pyrolytic graphite sheet produced by firing a polymer film at high temperature. This is because the pyrolytic graphite sheet has a high coefficient of thermal conductivity and is light and flexible to give an advantage of easy processing. As the polymer film, it is possible to use, for example, a heat-resistance aromatic polymer such as a polyimide, a polyamide, or a polyamide-imide. A temperature for firing the polymer film preferably ranges from 2600° C. to 3000° C., inclusive. The expanded graphite method is a method for forming an intercalation compound in natural graphite lead by treating the natural graphite lead with a strong acid such as sulfuric acid, heating and expanding the intercalation compound to produce expanded graphite, and subjecting the expanded graphite to rolling to form the expanded graphite into a sheet. The graphite film preferably has a thickness ranging from 10 μm to 100 μm, inclusive.

The pyrolytic graphite sheet preferably has an a-b plane-direction coefficient of thermal conductivity ranging from 700 W/(m·K) to 1950 W/(m·K), inclusive and preferably has a c-axis-direction coefficient of thermal conductivity ranging from 8 W/(m·K) to 15 W/(m·K), inclusive. The pyrolytic graphite sheet preferably has a density ranging from 0.85 g/cm³ to 2.13 g/cm³, inclusive. As such a pyrolytic graphite sheet, it is possible to use, for example, a “PGS (registered trademark) graphite sheet” manufactured by Panasonic Corporation.

Graphite layer 50 has a thickness ranging preferably from 5 μm to 500 μm, inclusive, more preferably from 10 μm to 200 μm, inclusive. Graphite layer 50 has a solid form as a surface form when viewed in thickness direction T of graphite composite film 1.

### (Second Electrically Conductive Adhesive Layer 60)

Graphite composite film 1 includes second electrically conductive adhesive layer 60. This configuration enables graphite composite film 1 to be adherent to an object, allowing graphite composite film 1 to both easily exhibit excellent heat dissipation properties and electrically connect graphite layer 50 to the object. Thus, metal layer 20 is electrically connected to the object, so that when the object has electric conductivity, graphite composite film 1 has more excellent electromagnetic wave shielding properties.

Second electrically conductive adhesive layer 60 includes, as shown in FIG. 6A, third adhesion layer 61, second metal substrate 62, and fourth adhesion layer 63 stacked in this order. Second electrically conductive adhesive layer 60 has the same structure as first electrically conductive adhesive layer 40.

In the present exemplary embodiment, second electrically conductive adhesive layer 60 includes, as shown in FIG. 6A, third adhesion layer 61, second metal substrate 62, and fourth adhesion layer 63 stacked in this order. The present disclosure, however, is not limited to this structure. As an exemplary alternative, second electrically conductive adhesive layer 60 may be a single layer formed of an electrically conductive resin. In the present exemplary embodiment, second electrically conductive adhesive layer 60 has the same structure as first electrically conductive adhesive layer 40. The present disclosure, however, is not limited to this configuration, and the second electrically conductive adhesive layer may have a different structure from the structure of first electrically conductive adhesive layer 40 as long as the second electrically conductive adhesive layer has electric conductivity and adhesion.

### [Manufacturing Method for Graphite Composite Film According to Present Exemplary Embodiment]

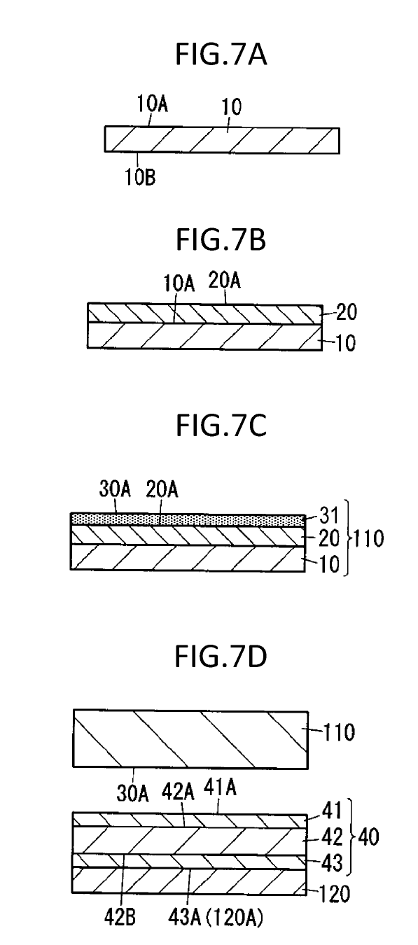

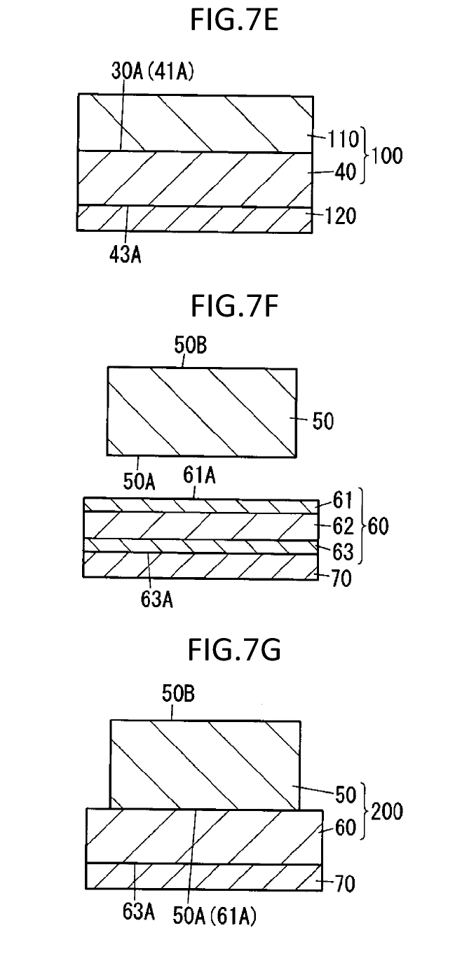

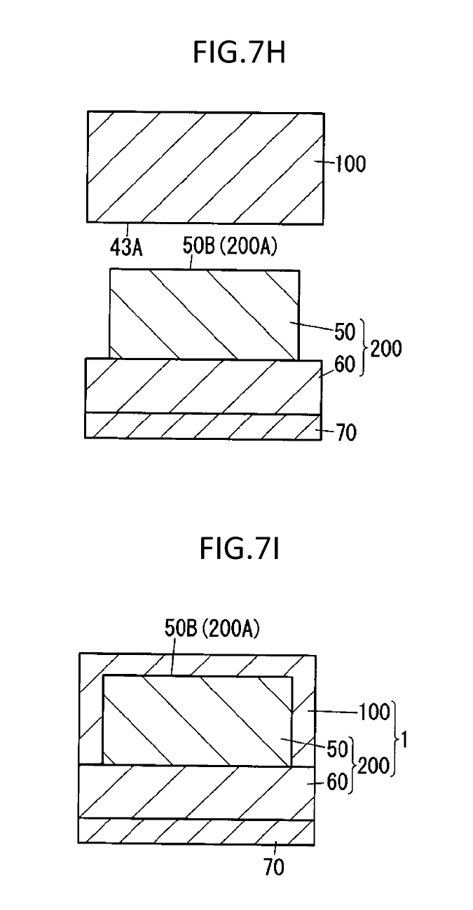

FIGS. 7A to 7I are schematic sectional views for illustrating a manufacturing method for graphite composite film 1 according to the present exemplary embodiment. Specifically, FIGS. 7A to 7E are schematic sectional views for illustrating step (2A) of preparing electrically conductive adhesive sheet-attached metal vapor-deposited film 100. FIGS. 7F and 7G are schematic sectional views for illustrating step (2B) of preparing electrically conductive adhesive sheet-attached graphite film 200. FIGS. 7H and 7I are schematic sectional views for illustrating step (2C) of subjecting electrically conductive adhesive sheet-attached metal vapor-deposited film 100 and electrically conductive adhesive sheet-attached graphite film 200 to lamination. Constituent members in FIGS. 7A to 7I that are identical with the constituent members of the exemplary embodiment shown in FIG. 6A are denoted by identical reference marks and are not described. Specifically, graphite film 50 corresponds to graphite layer 50, first electrically conductive adhesive sheet 40 corresponds to first electrically conductive adhesive layer 40, and second electrically conductive adhesive sheet 60 corresponds to second electrically conductive adhesive layer 60.

The manufacturing method for graphite composite film 1 according to the present exemplary embodiment includes step (2A) of preparing electrically conductive adhesive sheet-attached metal vapor-deposited film 100, step (2B) of preparing electrically conductive adhesive sheet-attached graphite film 200, and step (2C) of subjecting electrically conductive adhesive sheet-attached metal vapor-deposited film 100 and electrically conductive adhesive sheet-attached graphite film 200 to lamination. Steps (2A), (2B), and (2C) are performed in this order. These steps give graphite composite film 1 that is capable of attaining both a measure against heat and a measure against electromagnetic noise and that is less likely to cause degradation of electromagnetic wave shielding properties.

Step (2A): vapor deposition of a first metal is performed on first surface 10A of protection film 10 having first surface 10A and second surface 10B, to form metal layer 20, and rust proofing is performed on first surface 20A of metal layer 20 to form rust-proofing layer 31. Thus, metal vapor-deposited film 110 is prepared (hereinafter, step (2a1)). Thereafter, first electrically conductive adhesive sheet 40 is disposed on surface 30A of rust-proofing layer 31 in metal vapor-deposited film 110, thus laminating surface 30A with first electrically conductive adhesive sheet 40 (hereinafter, step (2a2)).

Step (2B): second electrically conductive adhesive sheet 60 is disposed on first surface 50A of graphite film 50 having first surface 50A and second surface 50B, thus laminating first surface 50A with second electrically conductive adhesive sheet 60.

Step (2C): electrically conductive adhesive sheet-attached metal vapor-deposited film 100 and electrically conductive adhesive sheet-attached graphite film 200 are subjected to lamination, with surface 43A of first electrically conductive adhesive sheet 40 and second surface 50B of graphite film 50 disposed so as to overlap one another.

In the present exemplary embodiment, steps (2A), (2B), and (2C) are performed in this order. The present disclosure, however, is not limited to this order. As an exemplary alternative, the steps may be performed in an order of steps (2B), (2A), and (2C).

### [Step (2A)]

Step (2A) includes step (2a1) of preparing metal vapor-deposited film 110 and step (2a2) of subjecting metal vapor-deposited film 110 and first electrically conductive adhesive sheet 40 to lamination that are performed in this order. These steps prepare electrically conductive adhesive sheet-attached metal vapor-deposited film 100.

(Step (2a1))

In step (2a1), vapor deposition of a first metal is performed on first surface 10A of protection film 10 shown in FIG. 7A to form metal layer 20 shown in FIG. 7B, and rust proofing is performed on first surface 20A of metal layer 20 to form rust-proofing layer 31 shown in FIG. 7C. Step (2a1) gives metal vapor-deposited film 110 shown in FIG. 7C.

A method for performing the vapor deposition of the first metal is preferably vacuum vapor deposition. Treatment conditions for the vacuum vapor deposition may be appropriately adjusted according to, for example, the type of the first metal and the thickness of metal layer 20.

A method for performing the rust proofing on first surface 20A of metal layer 20 may be appropriately adjusted as follows according to the raw material for rust-proofing layer 31.

When rust-proofing layer 31 is an organic coating film, examples of the method for performing the rust proofing on first surface 20A of metal layer 20 include a method for adding an above-mentioned raw material for the organic coating film to a solvent to give a rust-proofing liquid, applying the rust-proofing liquid to first surface 20A of metal layer 20, and drying the rust-proofing liquid. An addition amount of the raw material for the organic coating film may be appropriately adjusted according to, for example, the thickness of rust-proofing layer 31. The solvent may be appropriately adjusted according to the raw material for the organic coating film, and examples of the solvent include water and isoproprene alcohol. The rust-proofing liquid may contain another component as necessary. Examples of the other component include carboxylic anhydride. As the carboxylic anhydride, it is possible to use acetic anhydride, succinic anhydride, maleic anhydride, propionic anhydride, or phthalic anhydride. A method for applying the rust-proofing liquid is not particularly limited, and examples of the method include roller coating, roll coater coating, spin coater coating, curtain roll coater coating, slit coater coating, spray coating, and immersion coating. The rust-proofing liquid may be heated as necessary when dried.

When rust-proofing layer 31 is a metal coating film, the method for performing the rust proofing on first surface 20A of metal layer 20 may be appropriately adjusted according to, for example, the raw material for the metal coating film and the thickness of rust-proofing layer 31, and examples of the method include electroplating, electroless plating, physical vapor deposition, and chemical vapor deposition. Examples of the physical vapor deposition include vacuum vapor deposition, ion plating, and sputtering. Treatment conditions for the rust proofing may be appropriately adjusted according to, for example, the raw material for the metal coating film and the thickness of rust-proofing layer 31.

Step (2a1) may continuously manufacture metal vapor-deposited film 110 by, for example, continuously sending elongated protection film 10 out to a manufacturing step of performing the vapor deposition of the first metal and allowing the elongated protection film to go through the manufacturing step of performing the vapor deposition of the first metal and a manufacturing step of performing the rust proofing in this order.

(Step (2a2))

In step (2a2), first electrically conductive adhesive sheet 40 is, as shown in FIG. 7D, disposed on surface 30A of rust-proofing layer 31 in metal vapor-deposited film 110, thus laminating surface 30A with first electrically conductive adhesive sheet 40. At this time, second peeling sheet 120 is, as shown in FIG. 7D, fitted to surface 43A of first electrically conductive adhesive sheet 40 from a viewpoint of easy handling. Step (2a2) gives electrically conductive adhesive sheet-attached metal vapor-deposited film 100 shown in FIG. 7E.

Examples of a manufacturing method for second peeling sheet 120-fitted first electrically conductive adhesive sheet 40 shown in FIG. 7D include a method including following steps of:

applying an electrically conductive adhesive agent onto a surface of a third peeling sheet to form first adhesion layer 41;

applying an electrically conductive adhesive agent onto surface 120A of second peeling sheet 120 and drying the electrically conductive adhesive agent to form second adhesion layer 43; and

attaching first adhesion layer 41 and second adhesion layer 43 respectively to first surface 42A and second surface 42B of first metal substrate 42 having first surface 42A and second surface 42B, to form a laminated film, and curing the laminated film and then peeling the third peeling sheet from the laminated film.

Examples of a method for applying the electrically conductive adhesive agent include a method with use of, for example, a roll coater or a die coater.

When the electrically conductive adhesive agent contains a solvent, the drying is preferably performed in an environment with a temperature approximately ranging from 50° C. to 120° C. to remove the solvent. As a treatment condition for the curing, a treatment temperature preferably ranges from 15° C. to 50° C., inclusive, and a treatment period preferably ranges from 48 hours to 168 hours, inclusive. Second peeling sheet 120 and the third peeling sheet have the same structure as first peeling sheet 70.

Examples of a method for subjecting metal vapor-deposited film 110 and first electrically conductive adhesive sheet 40 to lamination include a method for disposing metal vapor-deposited film 110 and first electrically conductive adhesive sheet 40 such that surface 30A of metal vapor-deposited film 110 faces surface 41A of first electrically conductive adhesive sheet 40, and then making surface 30A of metal vapor-deposited film 110 adherent to surface 41A of first electrically conductive adhesive sheet 40 by pressure contact.

Step (2a2) may continuously manufacture electrically conductive adhesive sheet-attached metal vapor-deposited film 100 by, for example, sending elongated metal vapor-deposited film 110 and elongated first electrically conductive adhesive sheet 40 out to between a pair of rolls and sandwiching metal vapor-deposited film 110 and first electrically conductive adhesive sheet 40 between the pair of rolls for surface contact to perform lamination.

In the present exemplary embodiment, second peeling sheet 120 is fitted to surface 43A of first electrically conductive adhesive sheet 40. The present disclosure, however, is not limited to this configuration, and second peeling sheet 120 need not be fitted to surface 43A of first electrically conductive adhesive sheet 40.

### [Step (2B)]

In step (2B), second electrically conductive adhesive sheet 60 is, as shown in FIG. 7F, disposed on first surface 50A of graphite film 50 having first surface 50A and second surface 50B, thus laminating first surface 50A with second electrically conductive adhesive sheet 60. At this time, first peeling sheet 70 is, as shown in FIG. 7F, fitted to surface 63A of second electrically conductive adhesive sheet 60. This configuration gives an advantage of easy handling of second electrically conductive adhesive sheet 60. Step (2B) gives electrically conductive adhesive sheet-attached graphite film 200 shown in FIG. 7G.

Examples of a manufacturing method for first peeling sheet 70-fitted second electrically conductive adhesive sheet 60 shown in FIG. 7F include the same method as the above-mentioned manufacturing method for second peeling sheet 120-attached first electrically conductive adhesive sheet 40 shown in FIG. 7D.

Examples of a method for subjecting graphite film 50 and second electrically conductive adhesive sheet 60 to lamination include a method for disposing second electrically conductive adhesive sheet 60 as shown in FIG. 7F such that surface 61A of second electrically conductive adhesive sheet 60 is directed upward and placing graphite film 50 that has been cut into a prescribed dimension on surface 61A of second electrically conductive adhesive sheet 60. The dimension of cut graphite film 50 may be any dimension as long as entire graphite film 50 is, as shown in FIG. 7I, covered with electrically conductive adhesive sheet-attached metal vapor-deposited film 100 and electrically conductive adhesive sheet-attached graphite film 200. Entire graphite film 50 is covered with electrically conductive adhesive sheet-attached metal vapor-deposited film 100 and electrically conductive adhesive sheet-attached graphite film 200. This configuration is capable of preventing rupture of graphite composite film 1 attributed to interlayer peeling in graphite layer 50 and preventing powder dropping of graphite layer 50.

In step (2B), for example, second electrically conductive adhesive sheet 60 is continuously sent out to a laminate manufacturing step, and cut graphite film 50 is continuously placed, with a prescribed interval, on surface 61A of second electrically conductive adhesive sheet 60. Thus, electrically conductive adhesive sheet-attached graphite film 200 may be manufactured continuously.

In the present exemplary embodiment, cut graphite film 50 is placed on surface 61A of second electrically conductive adhesive sheet 60, thus laminating the surface with the graphite film. The present disclosure, however, is not limited to this lamination process. For example, the lamination may be performed by continuously sending each of elongated graphite film 50 and elongated second electrically conductive adhesive sheet 60 out to between a pair of rolls and sandwiching graphite film 50 and second electrically conductive adhesive sheet 60 between the pair of rolls for surface contact.

### [Step (2C)]

In step (2C), electrically conductive adhesive sheet-attached metal vapor-deposited film 100 and electrically conductive adhesive sheet-attached graphite film 200 are, as shown in FIG. 7H, subjected to lamination, with surface 43A of first electrically conductive adhesive sheet 40 and second surface 50B of graphite film 50 disposed so as to overlap one another. At this time, as shown in FIG. 7H, second peeling sheet 120 has been peeled, whereas first peeling sheet 70 is kept fitted from a viewpoint of easy handing of graphite composite film 1. Step (2C) gives graphite composite film 1 shown in FIG. 7I.

Examples of a method for subjecting electrically conductive adhesive sheet-attached metal vapor-deposited film 100 and electrically conductive adhesive sheet-attached graphite film 200 to lamination include a following method. The method is, for example, a method for disposing electrically conductive adhesive sheet-attached graphite film 200 as shown in FIG. 7H such that surface 200A on a graphite film 50-disposed side is directed upward, and thereafter placing electrically conductive adhesive sheet-metal vapor-deposited film 100 on surface 200A of electrically conductive adhesive sheet-attached graphite film 200 so as to cover entire graphite film 50.

In step (2C), for example, elongated electrically conductive adhesive sheet-attached metal vapor-deposited film 100 and elongated electrically conductive adhesive sheet-attached graphite film 200 are sent out to between a pair of rolls. Thereafter, the lamination is performed by sandwiching electrically conductive adhesive sheet-attached metal vapor-deposited film 100 and electrically conductive adhesive sheet-attached graphite film 200 between the pair of rolls for surface contact, and a resultant graphite composite film is cut into a necessary size. Thus, graphite composite film 1 may be manufactured continuously.

The present exemplary embodiment includes steps (2A), (2B), and (2C). The present disclosure, however, is not limited to this stacking order, and following methods are exemplified. A method is exemplified that includes subjecting metal vapor-deposited film 110, first electrically conductive adhesive sheet 40, graphite film 50, and second electrically conductive adhesive sheet 60 simultaneously to lamination to manufacture graphite composite film 1. A method is exemplified that includes subjecting first electrically conductive adhesive sheet 40, graphite film 50, and second electrically conductive adhesive sheet 60 to lamination to give a laminated film and subjecting the obtained laminated film and metal vapor-deposited film 110 to lamination to manufacture graphite composite film 1. A method is also exemplified that includes subjecting metal vapor-deposited film 110, first electrically conductive adhesive sheet 40, and graphite film 50 to lamination to give a laminated film and subjecting the obtained laminated film and second electrically conductive adhesive sheet 60 to lamination to manufacture graphite composite film 1.

Hereinafter, the present disclosure is specifically described with reference to an example.

### Example 3

### [Step (2A)]

(Step (2a1))

As protection film 10, a polyester film (“CX40” manufactured by Toray Industries, Inc., main raw material: PET, thickness: 6 μm) was prepared. Vacuum vapor deposition of copper (oxygen-free copper manufactured by Hitachi Metals Neomaterial, Ltd.) as the first metal was performed on first surface 10A of protection film 10 to form metal layer 20 (thickness: 1 μm) shown in FIG. 7B. Next, a rust-proofing agent (CI guard “GW-172P” manufactured by TOEI KASEI CO., LTD.) was applied to first surface 20A of metal layer 20 by roller coating and dried to form rust-proofing layer 31 (thickness: 4 nm) shown in FIG. 7C. These procedures gave metal vapor-deposited film 110 shown in FIG. 7C.

(Step (2a2))

As second peeling sheet 120-fitted first electrically conductive adhesive sheet 40, a sheet was prepared that was obtained by peeling a peeling sheet from one surface 41A of an electrically conductive double coated adhesive sheet (DAITAC (registered trademark) “#8506ADW-10-H2” manufactured by DIC Corporation, metal substrate: substrate formed of aluminum, thickness: 10 μm).

As shown in FIG. 7D, metal vapor-deposited film 110 and first electrically conductive adhesive sheet 40 were disposed such that surface 30A of metal vapor-deposited film 110 faced surface 41A of first electrically conductive adhesive sheet 40. Then, surface 30A of metal vapor-deposited film 110 was made adherent to surface 41A of first electrically conductive adhesive sheet 40 by pressure contact. These procedures gave electrically conductive adhesive sheet-attached metal vapor-deposited film 100 shown in FIG. 7E.

### [Step (2B)]

As first peeling sheet 70-fitted second electrically conductive adhesive sheet 60, a sheet was prepared that was obtained by peeling a peeling sheet from one surface 61A from an electrically conductive double coated adhesive sheet, i.e., the same product as first electrically conductive adhesive sheet 40. As graphite film 50, a graphite film (“PGS (registered trademark) graphite sheet” manufactured by Panasonic Corporation, thickness: 25 μm) cut into a size of 10 cm×12 cm was prepared.

As shown in FIG. 7F, second electrically conductive adhesive sheet 60 was disposed such that surface 61A of second electrically conductive adhesive sheet 60 was directed upward, and graphite film 50 was placed on surface 61A of second electrically conductive adhesive sheet 60. These procedures gave electrically conductive adhesive sheet-attached graphite film 200 shown in FIG. 7G.

### [Step (2C)]

As shown in FIG. 7H, electrically conductive adhesive sheet-attached graphite film 200 was disposed such that surface 200A on a graphite film 50-disposed side was directed upward. Then, electrically conductive adhesive sheet-attached metal vapor-deposited film 100 was placed on surface 200A of electrically conductive adhesive sheet-attached graphite film 200 so as to cover entire graphite film 50 and was cut into a size of 10 cm×12 cm. These procedures gave graphite composite film 1 shown in FIG. 7I.

### Comparative Example 3

Graphite composite film 1 was obtained in the same manner as in Example 3 except that rust-proofing layer 31 was not formed in step (2a1).

### [Test for Electromagnetic Wave Shielding Properties]

First peeling sheet 70 was peeled from obtained graphite composite film 1, and surface 1A of graphite composite film 1 was made adherent to a surface of an object by pressure contact to give sample 1. Sample 1 was subjected to an exposure treatment under exposure conditions of 40° C., 95% RH, and 250 hours to give sample 2 for the graphite composite film of each of Example 3 and Comparative Example 3.

Sample 3 was obtained in the same manner as sample 2 except that a temperature was set at 105° C. in the exposure treatment.

### [Measurement of Electromagnetic Wave Shielding Properties]

Samples 1, 2, and 3 peeled from the object were measured for electric field shielding performance and magnetic field shielding performance at a frequency range of 500 MHz in accordance with a EEC method of KEC Electronic Industry Development Center.

Table 2 shows measurement results of the electric field shielding performance and the magnetic field shielding performance of samples 1, 2, and 3.

TABLE 2

| | With or | | | Electric field | Magnetic field |
|---|---|---|---|---|---|
| | without rust- | | | shielding | shielding |
| | proofing layer | | Exposure treatment | performance | performance |
| | 31 | Sample | conditions | (500 MHz) | (500 MHz) |
| Example 3 | With | Sample 1 | Without | 82 dB | 57 dB |
| | | Sample 2 | 40° C., 95% RH, | 77 dB | 52 dB |
| | | | 250 hours | | |
| | | Sample 3 | 105° C., 250 hours | 71 dB | 54 dB |
| Comparative | Without | Sample 1 | Without | 82 dB | 53 dB |
| Example 3 | | Sample 2 | 40° C., 95% RH, | 57 dB | 40 dB |
| | | | 250 hours | | |
| | | Sample 3 | 105° C., 250 hours | 64 dB | 48 dB |

According to the present disclosure, it is possible to obtain a graphite composite film that is capable of attaining both a measure against heat and a measure against electromagnetic noise and that is less likely to cause degradation of electromagnetic wave shielding properties, and the graphite composite film is industrially useful.

What is claimed is:

1. A graphite composite film comprising:
a graphite layer, a first electrically conductive adhesive layer, and a metal layer containing a first metal disposed in this order;
a first rust-proofing layer interposed between the first electrically conductive adhesive layer and the metal layer, the first rust-proofing layer being disposed on a first surface of the metal layer; and
a second rust-proofing layer being disposed on a second surface of the metal layer opposite from the first surface.

2. The graphite composite film according to claim 1,
wherein the first metal is copper.

3. The graphite composite film according to claim 1,
wherein the first rust-proofing layer is an organic coating film.

4. The graphite composite film according to claim 3,
wherein the organic coating film is a benzotriazole coating film.

5. The graphite composite film according to claim 1,
wherein the first rust-proofing layer is a metal coating film containing, as a first rust-proofing metal, at least one selected from the group consisting of zinc, nickel, chromium, titanium, aluminum, gold, silver, palladium, and an alloy of these metals.

6. The graphite composite film according to claim 1,
wherein the second rust-proofing layer is an organic coating film.

7. The graphite composite film according to claim 6,
wherein the organic coating film is a benzotriazole coating film.

8. The graphite composite film according to claim 1,
wherein the second rust-proofing layer is a metal coating film containing, as a second rust-proofing metal, at least one selected from the group consisting of zinc, nickel, chromium, titanium, aluminum, gold, silver, palladium, and an alloy of these metals.

9. The graphite composite film according to claim 1,
wherein the first rust-proofing layer has a thickness of less than or equal to a thickness of the metal layer, and
the second rust-proofing layer has a thickness of less than or equal to the thickness of the metal layer.

10. The graphite composite film according to claim 9,
wherein the metal layer has a thickness ranging from 0.10 μm to 5.00 μm, inclusive,
the first rust-proofing layer has a thickness ranging from 0.002 μm to 0.100 μm, inclusive, and
the second rust-proofing layer has a thickness ranging from 0.002 μm to 0.100 μm, inclusive.

11. A manufacturing method for a graphite composite film, the method comprising the steps of:
performing vapor deposition of a first metal on a first surface of a protection film having the first surface and a second surface, to form a metal layer, performing first rust proofing on a surface of the metal layer to form a first rust-proofing layer, disposing a first electrically conductive adhesive sheet on a surface of the first rust-proofing layer, thus laminating the surface with the first electrically conductive adhesive sheet, and peeling the protection film and then performing second rust proofing on a surface of the metal layer opposite from the surface on a first rust-proofing layer-disposed side of the metal layer to form a second rust-proofing layer and thus prepare a first electrically conductive adhesive sheet-attached metal vapor-deposited film;
disposing a second electrically conductive adhesive sheet on a first surface of a graphite film having the first surface and a second surface, thus laminating the first surface with the second electrically conductive adhesive sheet, to prepare a second electrically conductive adhesive sheet-attached graphite film; and
subjecting the first electrically conductive adhesive sheet-attached metal vapor-deposited film and the second electrically conductive adhesive sheet-attached graphite film to lamination, with a surface of the first electrically conductive adhesive sheet and the second surface of the graphite film disposed so as to overlap one another.

12. The manufacturing method for a graphite composite film according to claim 11,
wherein the first metal is copper.

13. The manufacturing method for a graphite composite film according to claim 11,
wherein the first rust-proofing layer is a metal coating film containing, as a first rust-proofing metal, at least one selected from the group consisting of zinc, nickel, chromium, titanium, aluminum, gold, silver, palladium, and an alloy of these metals, or is an organic coating film.

14. The manufacturing method for a graphite composite film according to claim 11,
wherein the second rust-proofing layer is a metal coating film containing, as a second rust-proofing metal, at least one selected from the group consisting of zinc, nickel, chromium, titanium, aluminum, gold, silver, palladium, and an alloy of these metals, or is an organic coating film.

15. The manufacturing method for a graphite composite film according to claim 13,
wherein the organic coating film is a benzotriazole coating film.

16. A manufacturing method for a graphite composite film, the method comprising the steps of:
performing vapor deposition of a second metal and a first metal in this order on a first surface of a protection film having the first surface and a second surface, to form a second rust-proofing layer containing the second metal and a metal layer containing the first metal, performing rust proofing on a surface of the metal layer to form a first rust-proofing layer, disposing a first electrically conductive adhesive sheet on a surface of the first rust-proofing layer, thus laminating the surface with the first electrically conductive adhesive sheet, and peeling the protection film to prepare a first electrically conductive adhesive sheet-attached metal vapor-deposited film;
disposing a second electrically conductive adhesive sheet on a first surface of a graphite film having the first surface and a second surface, thus laminating the first surface with the second electrically conductive adhesive sheet, to prepare a second electrically conductive adhesive sheet-attached graphite film; and
subjecting the first electrically conductive adhesive sheet-attached metal vapor-deposited film and the second electrically conductive adhesive sheet-attached graphite film to lamination, with a surface of the first electrically conductive adhesive sheet and the second surface of the graphite film disposed so as to overlap one another.

17. The manufacturing method for a graphite composite film according to claim 16,
wherein the first metal is copper, and
the second metal is at least one rust-proofing metal selected from the group consisting of zinc, nickel, chromium, titanium, aluminum, gold, silver, palladium, and an alloy of these metals.

18. A graphite composite film comprising:
a graphite layer, a first electrically conductive adhesive layer, a metal layer containing a first metal, and a protection film disposed in this order; and
a rust-proofing layer interposed between the first electrically conductive adhesive layer and the metal layer.

19. The graphite composite film according to claim 18,
wherein the first metal is copper, and
the rust-proofing layer is an organic coating film.

20. The graphite composite film according to claim 19,
wherein the organic coating film is a benzotriazole coating film.

21. The graphite composite film according to claim 18,
wherein the first metal is copper, and
the rust-proofing layer contains, as a second metal, at least one selected from the group consisting of zinc, nickel, chromium, titanium, aluminum, gold, silver, palladium, and an alloy of these metals.

22. The graphite composite film according to claim 18,
wherein the rust-proofing layer has a thickness of less than or equal to a thickness of the metal layer.

23. The graphite composite film according to claim 22,
wherein the metal layer has a thickness ranging from 0.10 μm to 5.00 μm, inclusive, and
the rust-proofing layer has a thickness ranging from 0.002 μm to 0.100 μm, inclusive.

24. The graphite composite film according to claim 18, further comprising a second electrically conductive adhesive layer on a surface of the graphite layer opposite from a surface on a first electrically conductive adhesive layer-disposed side of the graphite layer.

25. A manufacturing method for a graphite composite film, the method comprising the steps of:
performing vapor deposition of a first metal on a first surface of a protection film having the first surface and a second surface, to form a metal layer, performing rust proofing on a surface of the metal layer to form a rust-proofing layer, and disposing a first electrically conductive adhesive sheet on a surface of the rust-proofing layer, thus laminating the surface with the first electrically conductive adhesive sheet, to prepare a first electrically conductive adhesive sheet-attached metal vapor-deposited film;
disposing a second electrically conductive adhesive sheet on a first surface of a graphite film having the first surface and a second surface, thus laminating the first surface with the second electrically conductive adhesive sheet, to prepare a second electrically conductive adhesive sheet-attached graphite film; and
subjecting the first electrically conductive adhesive sheet-attached metal vapor-deposited Min and the second electrically conductive adhesive sheet-attached graphite film to lamination, with a surface of the first electrically conductive adhesive sheet and the second surface of the graphite film disposed so as to overlap one another.

26. The manufacturing method for a graphite composite film according to claim 25,
wherein the first metal is copper, and
the rust proofing is forming a benzotriazole coating film on the surface of the metal layer.

27. The manufacturing method for a graphite composite film according to claim 25,
wherein the first metal is copper,
the rust proofing is performing vapor deposition of a second metal on the surface of the metal layer, and
the second metal is at least one selected from the group consisting of zinc, nickel, chromium, titanium, aluminum, gold, silver, palladium, and an alloy of these metals.
